(19) United States
(12) Patent Application Publication
(10) Pub. No.: US 2020/0356694 A1
(43) Pub. Date: Nov. 12, 2020

(54) ARCHITECTURE FOR DEVICE OWNERSHIP, DATA PROVENANCE, GOVERNANCE AND TRADE

(71) Applicant: QUALCOMM Incorporated, San Diego, CA (US)

(72) Inventors: Soo Bum Lee, San Diego, CA (US); Jay Rodney Walton, Waban, MA (US); John Wallace Nasielski, San Diego, CA (US); Gavin Bernard Horn, La Jolla, CA (US)

(21) Appl. No.: 16/866,438

(22) Filed: May 4, 2020

Related U.S. Application Data
(60) Provisional application No. 62/844,234, filed on May 7, 2019.

(51) Int. Cl. G06F 21/62; G06F 21/31; G06F 21/60; G06F 9/445

(52) U.S. Cl. CPC G06F 21/6245; G06F 21/31; G06F 2221/2141; G06F 9/44505; G06F 21/602

(57) ABSTRACT

Methods, systems, and devices for wireless communications are described. Aspects may include receiving, at a device, a device configuration profile including one or more parameters for managing data transfers associated with a service and generating a transaction credential by which the data is to be associated in a storage. The transaction credential may be generated according to the configuration profile. Aspects may also include identifying, at the device, that data is to be stored in the storage that is associated with the service. Aspects include signing the data using the transaction credential and transmitting the signed data to the storage.

### CROSS REFERENCE

The present application for patent claims the benefit of U.S. Provisional Patent Application No. 62/844,234 by LEE et al., entitled “ARCHITECTURE FOR DEVICE OWNERSHIP, DATA PROVENANCE, GOVERNANCE AND TRADE,” filed May 7, 2019, assigned to the assignee hereof, and expressly incorporated by reference herein.

### BACKGROUND

The following relates generally to wireless communications, and more specifically to architecture for device ownership, data provenance, governance and trade.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

A device, such as an Internet of Things (IoT) device may generate private data and transfer that data to storage such as a cloud-based storage. In some cases, data transferred to storage may lose privacy and/or be accessible by one or more entities, for example, a manager of the storage. Further, once private data has been shared, privacy or ownership over the data may be difficult to reclaim. In some cases, a receiving entity may desire to verify the authenticity of data produced by a device, and transferring accessible data (e.g., plain text data) to storage may make it difficult to determine whether the data has been modified. Techniques for establishing ownership of data, preserving privacy of the data, and establishing authenticity of the data may be desirable.

### SUMMARY

The described techniques relate to improved methods, systems, devices, and apparatuses that support architecture for device ownership, data provenance, governance and trade. Generally, the described techniques provide for an architecture and system for establishing ownership, preserving privacy and verifying authenticity of data produced by an electronic device such as an Internet of Things (IoT) device. The described techniques provide for a system that includes a device, an identity management system and a transaction management system. An owner of the device may register a management identification (ID) and owner credential at the identity management system. Further, the owner may register a device ID and device credential at the identity management system. The device may transmit a transaction identity (ID) and/or credential registration signed using the device credential to the identity management system to register a transaction credential associated with the device at the identity management system. The device may produce data and transmit data registration to a transaction management system. The data registration may include the data encrypted by the device and be signed using the transaction credential. Upon receiving the data, the transaction management system may verify the data transaction/registration by verifying that the transaction credential used to sign the data registration is registered at the identity management system. After verifying that the data registration is from an authorized device, the transaction management may transmit the encrypted data to the storage.

A method of communication at a device is described. The method may include receiving, at the device, a device configuration profile including one or more parameters for managing data transfers associated with a service, generating, at the device, a transaction credential by which the data is to be associated in the storage, the transaction credential generated according to the device configuration profile, identifying, at the device, that data is to be stored in a storage associated with the service, signing the data using the transaction credential, and transmitting the signed data to the storage.

An apparatus for communication at a device is described. The apparatus may include a processor, memory in electronic communication with the processor, and instructions stored in the memory. The instructions may be executable by the processor to cause the apparatus to receive, at the device, a device configuration profile including one or more parameters for managing data transfers associated with a service, generate, at the device, a transaction credential by which the data is to be associated in the storage, the transaction credential generated according to the device configuration profile, identify, at the device, that data is to be stored in a storage associated with the service, sign the data using the transaction credential, and transmit the signed data to the storage.

Another apparatus for communication at a device is described. The apparatus may include means for receiving, at the device, a device configuration profile including one or more parameters for managing data transfers associated with a service, generating, at the device, a transaction credential by which the data is to be associated in the storage, the transaction credential generated according to the device configuration profile, identifying, at the device, that data is to be stored in a storage associated with the service, signing the data using the transaction credential, and transmitting the signed data to the storage.

A non-transitory computer-readable medium storing code for communication at a device is described. The code may include instructions executable by a processor to receive, at the device, a device configuration profile including one or more parameters for managing data transfers associated with a service, generate, at the device, a transaction credential by which the data is to be associated in the storage, the transaction credential generated according to the device configuration profile, identify, at the device, that data is to be stored in a storage associated with the service, sign the data using the transaction credential, and transmit the signed data to the storage.

Some examples of the method, apparatuses, and non-transitory computer-readable medium described herein may further include operations, features, means, or instructions for generating, at the device, a transaction credential registration request by signing the transaction credential with a device credential, and transmitting the signed transaction credential to an identity management system.

In some examples of the method, apparatuses, and non-transitory computer-readable medium described herein, the transmitting includes sending the signed transaction credential to the identity management system that may be independent from the storage, and the device credential may be a permanent credential associated with the device.

Some examples of the method, apparatuses, and non-transitory computer-readable medium described herein may further include operations, features, means, or instructions for receiving a data production policy, and obtaining the data, at the device, according to the data production policy.

Some examples of the method, apparatuses, and non-transitory computer-readable medium described herein may further include operations, features, means, or instructions for encrypting the data prior to transmitting the signed data to the storage.

Some examples of the method, apparatuses, and non-transitory computer-readable medium described herein may further include operations, features, means, or instructions for receiving a security policy from the identity management system, and encrypting, at the device, the data based on the received security policy.

In some examples of the method, apparatuses, and non-transitory computer-readable medium described herein, the transaction credential and the device credential may be based on a device identification associated with the device.

In some examples of the method, apparatuses, and non-transitory computer-readable medium described herein, the device identification includes a temporary device identification, the transaction credential and the device credential may be based on the temporary device identification, and the device identification remains private based on using the temporary device identification.

In some examples of the method, apparatuses, and non-transitory computer-readable medium described herein, the transaction credential may be associated with the service.

A method of communication at an identity management node is described. The method may include receiving a device registration request for registration of a device credential associated with a device, receiving a transaction registration request for registration of a transaction credential by which data transmitted by the device is to be associated in a storage, receiving a transaction verification request for verification that data transmitted by the device is associated with the transaction credential, and verifying, in response to the transaction verification request, that the transaction credential is associated with the device.

An apparatus for communication at an identity management node is described. The apparatus may include a processor, memory in electronic communication with the processor, and instructions stored in the memory. The instructions may be executable by the processor to cause the apparatus to receive a device registration request for registration of a device credential associated with a device, receive a transaction registration request for registration of a transaction credential by which data transmitted by the device is to be associated in a storage, receive a transaction verification request for verification that data transmitted by the device is associated with the transaction credential, and verify, in response to the transaction verification request, that the transaction credential is associated with the device.

Another apparatus for communication at an identity management node is described. The apparatus may include means for receiving a device registration request for registration of a device credential associated with a device, receiving a transaction registration request for registration of a transaction credential by which data transmitted by the device is to be associated in a storage, receiving a transaction verification request for verification that data transmitted by the device is associated with the transaction credential, and verifying, in response to the transaction verification request, that the transaction credential is associated with the device.

A non-transitory computer-readable medium storing code for communication at an identity management node is described. The code may include instructions executable by a processor to receive a device registration request for registration of a device credential associated with a device, receive a transaction registration request for registration of a transaction credential by which data transmitted by the device is to be associated in a storage, receive a transaction verification request for verification that data transmitted by the device is associated with the transaction credential, and verify, in response to the transaction verification request, that the transaction credential is associated with the device.

Some examples of the method, apparatuses, and non-transitory computer-readable medium described herein may further include operations, features, means, or instructions for receiving, from the device, a signed transaction registration request, where the signed transaction registration request may be based on the device credential.

Some examples of the method, apparatuses, and non-transitory computer-readable medium described herein may further include operations, features, means, or instructions for verifying that the transaction credential may be associated with the device based on comparing the signed transaction registration request to the device credential.

Some examples of the method, apparatuses, and non-transitory computer-readable medium described herein may further include operations, features, means, or instructions for receiving an owner registration request for registration of an owner credential associated with the device, where the device registration request may be based on the owner credential.

Some examples of the method, apparatuses, and non-transitory computer-readable medium described herein may further include operations, features, means, or instructions for associating the transaction credential received from the device with the owner credential based on the device credential associated with the device.

Some examples of the method, apparatuses, and non-transitory computer-readable medium described herein may further include operations, features, means, or instructions for receiving a device ownership transfer request associated with the device, and associating a second transaction credential received from the device with a second owner credential based on the device ownership transfer request, where the second transaction credential may be received from the device after the device ownership transfer request.

Some examples of the method, apparatuses, and non-transitory computer-readable medium described herein may further include operations, features, means, or instructions for receiving a transaction verification identifier from a transaction management system that may be independent from the device, and verifying that the transaction credential may be associated with the device based on comparing the transaction verification identifier with the transaction credential and the device credential received from the device.

A method of communication at a transaction management node is described. The method may include receiving a data transmission from a device, where the data transmission includes data signed using a transaction credential associated with the device, communicating with an identity management node to verify that the transaction credential and the device are associated with each other, associating the data and the transaction credential in a storage network based on successful verification with the identity management node, receiving a request from an authorized entity to provide the data associated with the transaction credential, and providing the data in response to the request.

An apparatus for communication at a transaction management node is described. The apparatus may include a processor, memory in electronic communication with the processor, and instructions stored in the memory. The instructions may be executable by the processor to cause the apparatus to receive a data transmission from a device, where the data transmission includes data signed using a transaction credential associated with the device, communicate with an identity management node to verify that the transaction credential and the device are associated with each other, associate the data and the transaction credential in a storage network based on successful verification with the identity management node, receive a request from an authorized entity to provide the data associated with the transaction credential, and provide the data in response to the request.

Another apparatus for communication at a transaction management node is described. The apparatus may include means for receiving a data transmission from a device, where the data transmission includes data signed using a transaction credential associated with the device, communicating with an identity management node to verify that the transaction credential and the device are associated with each other, associating the data and the transaction credential in a storage network based on successful verification with the identity management node, receiving a request from an authorized entity to provide the data associated with the transaction credential, and providing the data in response to the request.

A non-transitory computer-readable medium storing code for communication at a transaction management node is described. The code may include instructions executable by a processor to receive a data transmission from a device, where the data transmission includes data signed using a transaction credential associated with the device, communicate with an identity management node to verify that the transaction credential and the device are associated with each other, associate the data and the transaction credential in a storage network based on successful verification with the identity management node, receive a request from an authorized entity to provide the data associated with the transaction credential, and provide the data in response to the request.

Some examples of the method, apparatuses, and non-transitory computer-readable medium described herein may further include operations, features, means, or instructions for receiving an access grant for the authorized entity to access the data associated with the transaction credential, where the access grant includes an ownership credential and access credential, and communicating with the identity management node to verifying that the transaction credential and the ownership credential may be associated with each other.

Some examples of the method, apparatuses, and non-transitory computer-readable medium described herein may further include operations, features, means, or instructions for receiving the transaction credential in the request from the authorized entity, where the transaction credential may be signed by the access credential, validating the request from the authorized entity based at least in part receiving the access credential, and retrieving the data associated with the transaction credential.

In some examples of the method, apparatuses, and non-transitory computer-readable medium described herein, the access grant for the authorized entity may be limited to the data associated with the transaction credential.

Some examples of the method, apparatuses, and non-transitory computer-readable medium described herein may further include operations, features, means, or instructions for recording the access grant for the authorized entity based on verifying that the transaction credential and the ownership credential may be associated with each other.

Some examples of the method, apparatuses, and non-transitory computer-readable medium described herein may further include operations, features, means, or instructions for validating an authenticity of the data based on verifying the transaction credential associated with the data, and communicating the validation to the authorized entity.

In some examples of the method, apparatuses, and non-transitory computer-readable medium described herein, providing the data may include operations, features, means, or instructions for transmitting encrypted data to the authorized entity.

Some examples of the method, apparatuses, and non-transitory computer-readable medium described herein may further include operations, features, means, or instructions for receiving a request from the device to access one or more locked capabilities of the device, where the request includes the transaction credential, receiving an access authorization credential associated with the transaction credential, verifying the request based on receiving the access authorization credential, and receiving a license grant for the one or more locked capabilities, where providing the data includes sending the license grant to the device.

### BRIEF DESCRIPTION OF THE DRAWINGS

FIG. 1 illustrates an example of a data management system that supports architecture for device ownership, data provenance, governance and trade in accordance with aspects of the present disclosure.

FIG. 2 illustrates an example of a process flow and a data management system in a data access context that supports architecture for device ownership, data provenance, governance and trade in accordance with aspects of the present disclosure.

FIG. 3 illustrates an example of a process flow and a data management system in an ownership transfer and data access context that supports architecture for device ownership, data provenance, governance and trade in accordance with aspects of the present disclosure.

FIG. 4 illustrates an example of a process flow and data management system in a licensing or activation context that supports architecture for device ownership, data provenance, governance and trade in accordance with aspects of the present disclosure.

FIG. 5 illustrates an example of a data ownership system that supports architecture for device ownership, data provenance, governance and trade in accordance with aspects of the present disclosure.

FIG. 6 illustrates an example of a system for wireless communications that supports architecture for device ownership, data provenance, governance and trade in accordance with aspects of the present disclosure.

FIGS. 7 and 8 show block diagrams of devices that support architecture for device ownership, data provenance, governance and trade in accordance with aspects of the present disclosure.

FIG. 9 shows a block diagram of a data configuration manager that supports architecture for device ownership, data provenance, governance and trade in accordance with aspects of the present disclosure.

FIG. 10 shows a diagram of a system including a device that supports architecture for device ownership, data provenance, governance and trade in accordance with aspects of the present disclosure.

FIGS. 11 and 12 show block diagrams of devices that support architecture for device ownership, data provenance, governance and trade in accordance with aspects of the present disclosure.

FIG. 13 shows a block diagram of a data configuration manager that supports architecture for device ownership, data provenance, governance and trade in accordance with aspects of the present disclosure.

FIG. 14 shows a diagram of a system including a device that supports architecture for device ownership, data provenance, governance and trade in accordance with aspects of the present disclosure.

FIGS. 15 through 18 show flowcharts illustrating methods that support architecture for device ownership, data provenance, governance and trade in accordance with aspects of the present disclosure.

### DETAILED DESCRIPTION

Various electronic devices such as mobile phones, smartphones, tablets, IoT devices, sensors, measurement devices, computer hardware, etc., may generate, collect or store data. In many cases, an electronic device may transmit the data through a network such a wireless communication system, wired communication system or the like to one or more storages, for example to a cloud-based storage. The storage may be operated and owner by a different entity from the device owner. Further, in many cases an accessible form of the data (e.g., plain text data) is transmitted to the storage. Thus, an owner of the device or data produced by the device may lose control over the data once it has been transmitted over a network. For example, the data may be accessible by other entities (e.g., storage owner, network operator, etc.), and thus, transmitting the data may result in privacy of the data being lost or compromised. Further, once privacy of the data is lost it is hard to reclaim or re-establish. Additionally, once the data is transferred via a network, control over the data may also be lost. That is, the device or data owner may not be able to control who receives or views the data. In some cases, authenticity of the data may also be lost. That is, a receiver of the data may have no way of knowing whether the data generated at the device has been modified or otherwise compromised during the transfer process.

Aspects of the disclosure include a data management system for managing the control, privacy and authenticity of data produced by a device. The data management system may include independent management components each configured to perform defined and independent aspects of a data transfer process. In this regard, compromise of one or more of the independent management components does not result in the data being compromised. The data management system may include an identity management system for an owner to register an owner credential and device ID for a device owned by the owner. The identity management system may associate one or more device IDs (e.g., transaction credentials) with the owner of a device. In this regard, data produced by a device may be associated with different services or different owners and can be tracked, transferred or accessed by different entities that are authorized by an owner of the device. In some cases, an owner may manage a device through an owner node that is registered at the identity management system. The owner via the owner node may configure the device with a configuration profile to implement one or more polices on the device. In some cases, the configuration profile may include a data collection policy for generating data at the device (e.g., collection frequency, triggering events, data type, etc.) or a security policy for encrypting and transferring data to a storage.

The data management system may also include a transaction management system for managing the transfer of data generated at a device. The transaction management system may receive encrypted data from a device and verify that the data is from an authorized device. For example, the transaction management system may communicate with the identity management system to confirm that a signature used to transmit the data to the transaction management system is generated using the credential registered at the identity management system. Upon verifying the signature, the transaction management system may transfer the encrypted data to a storage. In this regard, the identity management system may not receive any data from the device and the transaction management system may not receive an owner identification for the data. Further, encrypting the data at the device preserves privacy of the data, and transmitting the data to the transaction management system independent of the identity management system separates the owner from a transaction ID associated with the data. In this regard, the owner remains control over the data, and can associate data produced at the device with different transaction IDs allowing the owner to independently transfer different types of data (e.g., associated with different service) to different entities.

Aspects of the disclosure include an owner of the device registering a management identification (ID) and owner credential at the identity management system. Further, the owner may register a device ID and device credential at the identity management system. The device may transmit a transaction registration signed using the device credential to the identity management system to register a transaction credential associated with the device or service of the device at the identity management system. The device may produce data and transmit a data registration to a transaction management system. The data registration may include the data encrypted by the device and be signed using the transaction credential. Upon receiving the data, the transaction management system may verify the data registration by verifying that the transaction credential used to sign the data registration is registered at the identity management system. After verifying that the data registration is from an authorized device, the transaction management may transmit the encrypted data to the storage.

In some cases, an owner, via an owner node, may transmit an access grant to the transaction management system. The access grant may authorize a receiving entity access to data generated by the device. The transaction management system may verify the access grant with the identity management system, for example, by verifying that a management credential used to sign the access grant is registered at the identity management system. The access grant may further identify an access credential associated with data that is being accessed by the receiving entity. The receiving entity may transmit an access request to the transaction management system for the data associated with the transaction credential. The access request may be signed by the receiving entity. Upon verifying that the access has been granted to the receiving entity by the owner, the transaction management system may transmit the data associated with the transaction credential to the receiving entity. The receiving entity may decrypt the data using the encryption key used by the device. In some cases, the encryption key may be securely communicated to the receiving entity from the owner of the device. In this case, the encryption key may be further encrypted using the public key of the receiving entity. Only the receiving entity can decrypt and obtain the encryption key received from the owner.

Aspects of the disclosure are initially described in the context of a system diagram. Aspects of the disclosure are then described in the context of a process flow diagram, system diagrams and a wireless communications system. Aspects of the disclosure are further illustrated by and described with reference to apparatus diagrams, system diagrams, and flowcharts that relate to architecture for device ownership, data provenance, governance and trade.

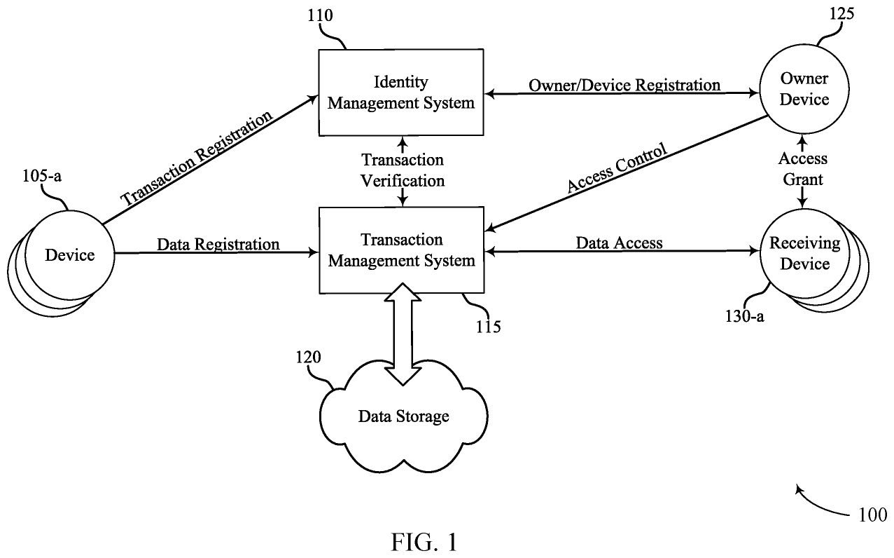

FIG. 1 illustrates an example of a data management system 100 that supports architecture for device ownership, data provenance, governance and trade in accordance with aspects of the present disclosure. The data management system 100 may support the collection, storage and transfer of data between an electronic device 105, identity management system 110, transaction management system 115, data storage 120, owner device 125 and receiving device 130 where, the authenticity and transfer of data collected at the wireless device 105 may be controlled by the owner device 125.

In some examples, the data management system may include one or more electronic devices 105, owner devices 125, and receiving devices 130 (e.g., receiving entity), which may be examples of a user equipment (UE) as described herein. The data management system 100 may further include the identity management system 110, the transaction management system 115 and the data storage 120, which may be examples of database management systems, or cloud-based storage systems as described herein. The one or more wireless devices 105, owner device 125, and receiving entity device 130 may establish communications and transfer data with the identity management system 110 or transaction management system 115 via one or more wired or wireless networks, which may include one or more base stations or core networks as described herein.

The electronic device(s) 105 may be an example of a wired or wireless device and be configured to collect and store data in electronic form. In some examples, the electronic device 105 may be one or more of a mobile device such as a smartphone, tablet, smart watch, medical device, sensor, or the like and collect data associated with using the device. In some cases, the electronic device 105 may be one or more of an internet of things (IoT) device and may include one or more sensors, inputs, or other hardware for collecting or receiving data. In other cases, the electronic device 105 may be a device that is configured to receive, transmit, store or otherwise process data. The electronic device 105 may determine that data is to be stored in the data storage 120 and perform one or more processes to establish ownerships of the data (e.g., that the electronic device 105-a was the producer of the data), secure the data or retain privacy of the data (e.g., by encrypting the data) and provide access to the data (e.g., allow a receiving device 130-a to access the data from the data storage 120).

In some cases, the data management system 100 may establish ownership of data through an owner device 125. The owner device 125 may interact with the identity management system 110 to register a device 105 or establish that it is the owner of the device 105. In some cases, this may include the owner device 125 registering a management ID (e.g., owner ID) and owner credential at the identity management system 110, where the management ID uniquely identifies the owner device 125. The owner device 125 may also register one or more devices 105 with the identity management system 110. This may include, the owner device 125 registering a device ID and device credential at the identity management system 110. In some cases, the owner credential and device credential may include a unique digital credential such a digital signature, certification, key pair, password or the like, or any credential that is used to authenticate the management ID associated with the owner device 105 or the device ID associated with the wireless device. Accordingly, the identity management system 110 may store information relating the owner device 125 (e.g., owner ID) to the device 105 (e.g., device ID).

One or more management credentials (e.g., management ID, owner credential) may be used to register or de-register one or more devices 105 with the identity management system 110. That is, the owner device 125 may use the management credential to establish ownership of one or more devices or certain data produced by the devices 105. In some case, the management credentials may also be used to enforce one or more policies of the one or more devices 105, such as ownership change, data collection, data transfer, data storage, data privacy, security, or the like.

In some cases, the device 105 and owner device 125 may be a single device. For example, the wireless device may register a device ID to the identity management system 110 and provide ownership credentials establishing itself as the owner of any data that it produces. In some cases, the owner device 125 may be further associated with an ownership entity, for example, a person(s), a business entity, a different device, etc.

The device 105 may operate (e.g., collect data, store data, apply privacy policy, apply security policy, transfer data, provide reports, or the like) according to one or more device configuration profiles. In some examples, the owner device 125 may provision or send the device 105 one or more configuration profiles. The owner device 125 may send the one or more configuration profiles to the device 105 in a variety of ways. For example, the owner device 125 may send the configuration profiles to the device 105 via the transaction management system 115. In some cases, the owner device 125 may send the configuration profiles to the device 105 via communication channels that are not part of the data management system 100, for example, over one or more independent wired or wireless networks.

In some cases, the device 105 may be configured with an initial set of configuration/operating profiles. That is, the device may operate according to the initial set of profiles until a communication connection is established between the device 105 and other parts of the data management system 100 (e.g., owner device 125, identity management system or transaction management system 115). In some cases, the initial set of configuration profiles may include one or more parameters for collecting data (e.g., frequency, triggers, type, etc.), security parameters for managing data or communicating with other parts of the data management system 100, or the like. The device 105 may operate according to the initial set of configuration parameters until a new or updated configuration parameter is received from the data management system 100, for example, from the owner device 125.

A first device 105-a may identify data to be stored in a data storage 120 (e.g., cloud-based storage), for example, according to one or more parameters configured by the owner device 125. The first device 105-a may send a transaction identifier and credential registration to an identity management system 110, which may be associated with a service and/or the corresponding data. In some cases, the transaction registration may include a device credential, for example, the transaction registration may include the device ID signed by the device credential. In this regard, the identity management system may verify that the device credential has been registered by an owner device 125 and establish that the device ID associated with that credential is a device ID that is associated with an owner device 125. In some cases, the device credential may be a private credential only known by the owner device 125 and the first device 125-a. In some examples, the device ID may be a permanent device ID associated with the device (e.g., a vehicle identification number (VIN), patient medical record number (MRN), or the like) or a temporary device ID that is associated with a permeant device ID, and may be used to preserve the privacy of the permanent device ID. In some cases, the device ID, transaction credential, or a combination thereof may be temporary IDs/credentials, which may be associated with a service. For example, a temporary device ID and credential may be used to associate data produced at the device with a specific service.

The first device 105-a may also send a data registration to a transaction management system 115, which may include the data and a transaction credential. In response to receiving the data registration, the transaction management system 115 may verify the transaction credential with the identity management system 110 and store the data in the data storage 120. In some cases, this may include the identity management system 110 verifying a transaction ID, a credential or a combination thereof. In some examples, the first device 105-a may encrypt the data as part of the data registration process. The encryption may occur via a private data credential (e.g., private key). In this regard, data produced by the device 105-a may only be accessible (e.g., decrypted) by a device (e.g., a receiving device 130) that has access to the private data credential. For example, encrypted data may be sent to the transaction management system 115 to be stored in the data storage 120, thereby preventing the transaction management system or data storage 120 for accessing the content of the data.

In some cases, the owner device 125 may access the data or grant access to one or more receiving devices 130. This may include the owner device 125 providing an access credential to the transaction management system 115, to verify that the owner device 125 is authorized to access the stored data. In cases, where the owner device 125 grants access to a receiving device 130, the owner may grant access to a receiving device 130 via the transaction management system 115 and provide the receiving device 130 with an access credential. The receiving device 130 may request the data and the transaction management system 115 may verify that the receiving device 130 has been granted access by the owner device 125. In some cases, this may include the receiving device 130 providing the access credential to the transaction management system 115. If the transaction management system 115 verifies the access credential, from the owner device 125 or receiving entity device 130, the transaction management system may retrieve the data from the data storage 120 and transmit it to the owner device 125 or the receiving entity device 130. The access credential may be an access token that is associated with the device 130-a. Alternatively, the access credential may be the public key of the device 130-a. In this case, the data request includes the signature of the data request message that is generated associated private key of the device 130-a.

In some cases, a first device 105-a may change ownership from a first owner associated with the owner device 125 to a second owner. The ownership transfer may be established at the identity management system, for example, by the owner device 125. In some examples, the identity management system 110 may record that the device ID associated with the first device 105-a is transferred from the owner device 125 (e.g., first owner) to a second owner device. In some examples, after the transfer, the device 105-a may use the device ID or generate a new device ID and register the new device ID at the identity management system.

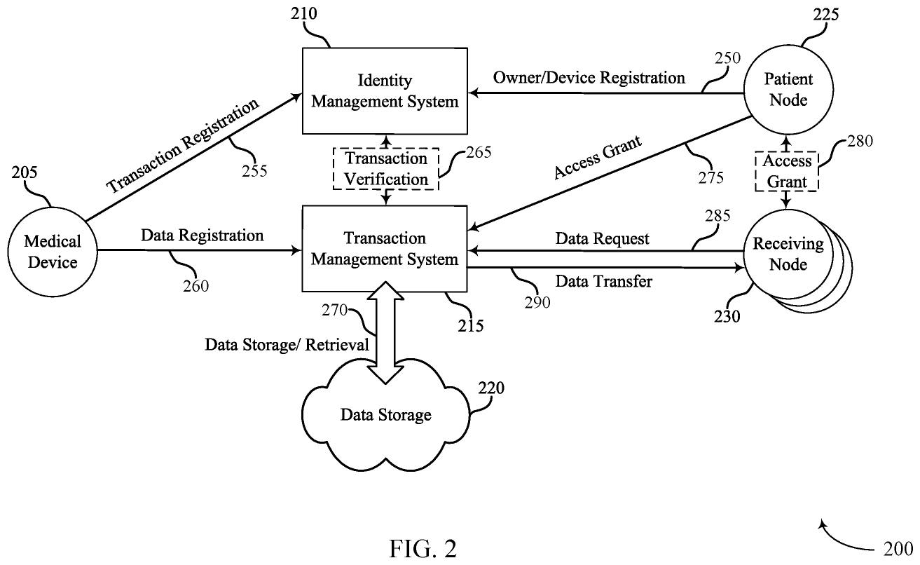

FIG. 2 illustrates an example of a process flow for a data management system 200 that supports architecture for device ownership, data provenance, governance and trade medical device example. The process flow illustrates an access grant from a data owner (e.g., patient) to a receiving entity (e.g., doctor) for data generated by a medical device (e.g., medical device 205). In some examples, the data management system 200 may implement aspects of data management system 100. The data management system 200 may include a medical device 205, which may be an example of an electronic device 105 as described with reference to FIG. 1; an identity management system 210, which may be an example of the identity management system 110 as described with reference to FIG. 1; a transaction management system 215, which may be an example of the transaction management system 115 as described with reference to FIG. 1; a data storage 220, which may be an example of the data storage 120 described with reference to FIG. 1; a patient node 225, which may be an example of the owner/owner device 125 as described with reference to FIG. 1; and a receiving node 230, which may be an example of the receiving device as described with reference to FIG. 1.

The data management system 200 may be configured to securely transfer data collected at a medical device 205 to one or more receiving nodes 230. In some cases, the medical data transfer system may transfer data from the medical device 205 to a receiving node 230 that is independent of the medical device 205. For example, the medical device 205 may be at a first location and under control of a first entity such as a first doctor, hospital, or a patient, and data collected by the medical device may be transferred to a receiving entity that is independent (e.g., a different doctor, hospital, analysis entity or the like) from the first entity, while preserving the privacy and authenticity of the data produced by the medical device 205.

At 250, the process flow may include an owner/patient registering a management ID at the identity management system 210 via the patient node 225 (e.g., an electronic device). In some cases, the management ID may include a patient ID such as medical record number or other identification. In some examples, the management ID may include an alias ID that is associated with the patient ID at the identity management system 210. The alias ID may be used to preserve patient privacy or security. In this regard, the patient ID may be securely stored on the identity management system 210 and not accessed or otherwise shared with the transaction management system 215 or be directly associated with data transferred to the transaction management system 215 from the medical device 205. At 250, the patient node 225 may also register a management credential at the identity management system 210. The management credential may include a medical device ID (e.g., for medical device 205), a security credential, or the like. In some cases, the management credential may establish the patient's ownership or right to access data produced by the medical device 205.

Additionally or alternatively, the patient node 225 may transmit one or more configuration profiles to the medical device 205. In some cases, this may include a security profile, for example, to encrypt data, generate security keys, produce meta-data, or the like for data produced by the medical device 205. In some case, the configuration profile may include a data production policy (e.g., triggering condition such as timing or event), a data reporting policy (e.g., frequency, receiving entity, etc.), or the like. The medical device 205 may collect, store or organize data according to one or more of the configuration policies.

At 255, the process flow may include the medical device 205 transmitting a transaction registration, which may include a transaction identifier and credential registration, to the identity management system 210. The transaction identifier may serve as an identifier of the medical device for a specific set of data or one or more services. In some cases, the medical device 205 may register multiple transaction credentials at the identity management system 210. For example, a first transaction credential may be associated with a first set or type of data (e.g., data relating to a medical measurement, which may be owned by the patient) produced by the medical device 205 and a second transaction credential may be associated with a second set or type of data (e.g., data relating to functioning of the device, such as battery life, which may be owned by a different entity such as a hospital). The transaction credential may serve as a permanent or temporary identifier of the medical device 205 and be configured according to a configuration policy, for example, a policy received from the patient node 225, a different owner node (e.g., a hospital that owns the medical device), an entity given access to the medical device 205 such as a doctor or device the doctor controls, or the like.

In some cases, the transaction registration may be signed by the medical device 205 using a master credential known to the medical device 205 and the identity management system 210. For example, the master credential may include a digital signature based on the master credential registered at the identity management system 210. Accordingly, the identity management system 210 may receive the transaction registration, verify that the medical device 205 is associated with the patient node 225 and associate the transaction credential with the patient node 225.

At 260, the process flow may include the medical device 205 transmitting a data registration to the transaction management system 215 for data to be stored at the data storage 220. The data registration may include data collected at the medical device 205 and be signed using the transaction credential that was registered at the identity management system 210. In some cases, the medical device 205 may encrypt the data prior to transmitting the data registration to the transaction management system 215. For example, the data may be encrypted according to a security policy received in the configuration profile. In some cases, the data may be encrypted using private encryption techniques such as a private key pair.

At 265, upon receiving the data registration, the transaction management system 215 may verify that medical device is authorized to store data at the data storage 220. In some cases, the transaction management system may verify the data registration by verifying the transaction ID, transaction credential used to sign the data registration, or a combination thereof with the identity management system 210. For example, the identity management system 210 may confirm that the transaction credential provided by the transaction management system 215 is associated with the transaction credential that was registered by the by the medical device 205. In this regard, the identity management system 210 does not receive any data collected by the medical device 205 and the transaction management system 215 does not receive the encryption key used to encrypt the data or the master credential that associates the medical device 205 with the patient node 225. Accordingly, in the event that the identity management system 210 or the transaction management system is compromised, an unauthorized entity would not be able to access the data due to the encryption or associate the data with the patient due.

At 270, the transaction management system 215 may store the encrypted data in the data storage 220. In some cases, this may include storing the data based on an ID associated with the transaction credential. In some cases, the data may include metadata that associates the data with the transaction credential. The data storage 220 may include cloud-based storage, local or remote data store, or the like as described herein.

At 275, the patient node 225 may initiate a transfer of the data collected from the medical device 205 and stored in the data storage 220 to one or more receiving nodes 230. The patient node 225 may transmit an access grant to the transaction management system 215. The access grant may include an authorization for the receiving node 230 to access data associated with the transaction credential used by the medical device 205 to register the data. The access grant may also be signed by the patient node 225, for example, using the owner/patient credential that was registered to the identity management system 210 at step 250. In this regard, the transaction management system 215 may verify the access grant received from the patient node 225 by verifying the patient credential with the identity management system 210. Upon verifying the access grant from the patient node 225, the transaction management system 215 may register or record the authorization for the receiving node 230 to access data associated with the transaction credential registered by the medical device 205.

At 280, the patient node 225 may also transmit an indication of the access grant to the receiving node 230. The indication of the access grant may include the transaction credential for identifying the data and access credential for requesting the data from the transaction management system 215. In some cases, the access grant may also include an encryption key for decrypting the data stored at the data storage 220.

At 285, the receiving node 230 may transmit a data request to the transaction management system 215 including the transaction credential for data collected by the medical device 205 and stored at the transaction management system 215. The data request may be signed by the receiving node 230 using the access credential received from the patient node 225 and registered at the transaction management system 215. In some cases, the transaction credential may be used by the transaction management system 215 to identify the data collected by the medical device 205.

At 290, the transaction management system 215 may verify the data request based on the signature included in the data request and the access credential registered by the patient node 225. Upon verifying the data request, the transaction management system 215 may access the data associated with the transaction credential and transmit the encrypted data to the receiving node 230. The receiving node 230 may decrypt the data using a private encryption key and have access to the data produced by the medical device 205.

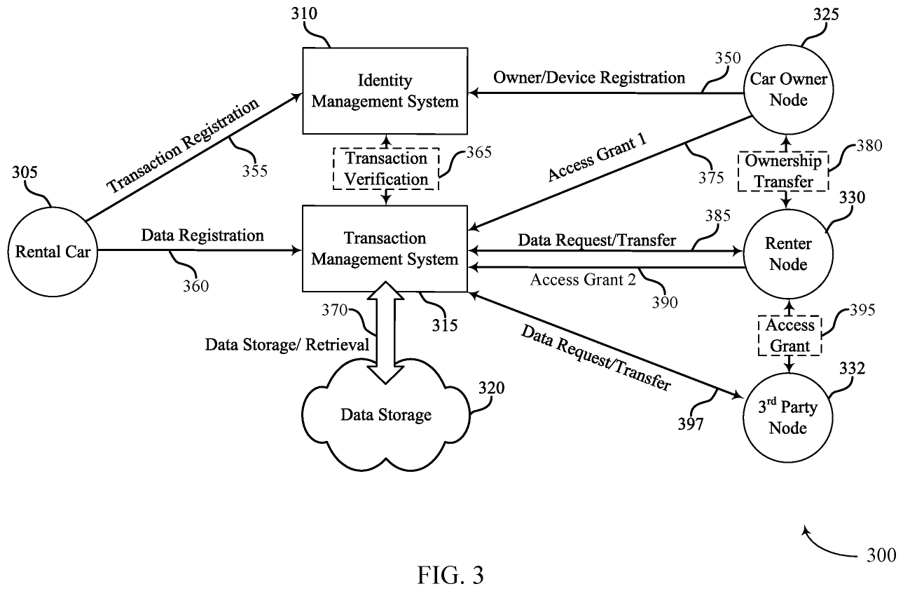

FIG. 3 illustrates a process flow for a data management system 300 that supports architecture for device ownership, data provenance, governance and trade in a rental car example. The process flow illustrates an ownership transfer of data from a device owner (e.g., rental car company) to a receiving entity (e.g., renter) for data generated by a rental car. Further, the process flow illustrates an access grant from a renter to a third part (e.g., insurance company) for data owned by the renter (e.g., data generated by a rental car while the renter was using it). In some examples, the data management system 300 may implement aspects of data management systems 100 and 200. The data management system 300 may include a rental car 305, which may be an example of an electronic device 105 as described with reference to FIG. 1 or perform similar processes as the medical device 205 as discussed with reference to FIG. 2; an identity management system 310, which may be an example of the identity management system 110 or 210 as described with reference to FIGS. 1 and 2; a transaction management system 315, which may be an example of the transaction management system 115 or 215 as described with reference to FIGS. 1 and 2; a data storage 320, which may be an example of the data storage 120 or 220 described with reference to FIGS. 1 and 2; a car owner node 325, which may be an example of the owner/owner device 125 or patient node 225 as described with reference to FIGS. 1 and 2; a renter node 330, which may be an example of the receiving device 130 or receiving node 230 as described with reference to FIGS. 1 and 2; and a third party node 332.

The data management system 300 in the rental car example illustrates how both ownership and authorization to access data generated by a device (e.g., rental car 305) may be transferred between different entities while maintaining the security, privacy and provenance (e.g., authenticity) of the data. For example, a rental car 305 may be owned by rental car company and managed using the car owner node 325, which may be an electronic device controlled by the rental car company. At 350, the car owner may register a management ID and management credential at the identity management system 310, which may be an example of the management ID and management credential registration discussed in relation to FIGS. 1 and 2. Additionally or alternatively, the car owner node 325 may establish ownership of the rental car 305 by registering a device ID (e.g., a rental car ID such as a vehicle identification number (VIN)) and a master credential associated with the device ID (e.g., digital certificate).

In some cases, for example, in a rental car context, a device owner (e.g., rental car company) may grant or transfer rights to data produced by the device to a device user (e.g., car renter). For example, a rental car company may grant rights to the renter including rights to the data produced by the rental car while the renter is using the car. The rental car company via the car owner node 325 may configure the rental car 305 with a configuration profile to be implemented during the rental period. In some cases, the configuration profile may include a device configuration policy for generating a transaction credential at the rental car 305. In this regard, a first transaction credential may be associated with a first renter during a first rental period. In some cases, such as car rental, a transaction credential may be used to associate data produced by the device (e.g., rental car 305) with a specific user (e.g., first renter). Further, a single device (e.g., rental car 305) may generate multiple transaction credentials and associate data produced by the device with different ones of these transaction credentials. For example, the rental car may be used during a different period by a second renter and the rental car 305 may generate a second transaction credential to associate data generated during the second rental period to the second renter.

At 355, the rental car 305 may transmit a transaction registration including a first transaction credential to the identity management system 310. The rental car 305 may sign the transaction registration using the master credential and the identity management system 310 may verify and associated the first transaction credential with the car owner via the car owner node 325, which may be an example of the signature and verification process discussed at 255 in relation to FIG. 2.

At 360, the rental car 305 may transmit a data registration to the transaction management system, which may be an example of the data registration process 260 discussed in relation to FIG. 2. In some cases, the data registration may be for data generated by the rental car 305 while a first renter was using the rental car 305. This may include associating the data with the first registration credential at the transaction management system 360 by signing the data registration with the first registration credential.

At 365, the transaction management system 315 may verify the first transaction credential with the identity management system 310. This may include the transaction management system verifying that the first registration credential used to sign the data registration is also registered at the identity management system (e.g., at step 355). At 370, upon verifying the data registration at 365, the transaction management system 315 may transmit the data and associated first transaction credential to the data storage 320, which may be an example of the data storage process 270 discussed in relation to FIG. 2.

At 375, the car owner node 325 may transfer ownership of the data collected at the rental car 305, while the first renter was using the car, to the first renter via the renter node 330. The car owner node 325 may transmit an ownership grant to the transaction management system 315. The ownership grant may indicate that ownership of the data associated with the first transaction credential is being shared with or transferred to the renter via the renter node 330. The ownership grant may be signed by the car owner node 325, for example using the owner credential that was also registered to the identity management system 310 at step 350. In some cases, the transaction management system 315 may verify the ownership grant received from the car owner node 325 by verifying the owner credential with the identity management system 310. Upon verifying the ownership grant from the car owner node 325, the transaction management system 315 may register or record the ownership grant for the renter node 330.

At 385, the renter node 330 may request and receive the data associated with the first transaction credential from the transaction management system 315. This may include transmitting a data request to the transaction management system 315 that includes the first transaction credential signed by the renter node 330. The request and data transfer at 385 may be an example of the request and data transfer at steps 285 and 290 described with reference to FIG. 2.

At 390, the renter node 330 may initiate a transfer of the data collected at the rental car during the first rental period to one or more third party nodes (e.g., insurance company). The renter node 330 may transmit an access grant to the transaction management system 315, for example, based on the ownership transfer at 380. The access grant may include an authorization for the third party node 332 to access data associated with the first transaction credential used by the rental car 305 to register the data. The access grant may also be signed by the renter node 330, for example, using a renter node credential. The transaction management system 315 may register or record the authorization for the receiving third party node 332 to access data associated with the first transaction credential.

At 395, the renter node 330 may also transmit an indication of an access grant to the third party node 332. The indication of the access grant may include the transaction credential for identifying the data and access credential for requesting the data from the transaction management system 315. In some cases, the access credential may be a token as described herein. In some case, the access grant may also include an encryption key for decrypting the data stored at the data storage 320.

At 397, the third party node 332 may transmit a data request to the transaction management system 315 including the first transaction credential for data collected by the rental car 305 during the first rental period. The data request may be signed by the third party node 332 using the access credential received from the renter node 330 and registered at the transaction management system 315. In some cases, the first transaction credential may be used by the transaction management system 315 to identify the data generated by the rental car 305 during the first rental period.

The transaction management system 315 may verify the data request based on the signature included in the data request and the access credential registered by the renter node 330. Upon verifying the data request, the transaction management system 315 may access the data associated with the first transaction credential and transmit the encrypted data to the third party node 332. The third party node 332 may decrypt the data using a private encryption key and have access to the data generated by the rental car 305 during the first rental period.

In some cases, provenance of the data may be established by the process flow carried out by the data management system 300. That is, the authenticity of the data generated by the rental car 305 may be established based on the process flow described herein. For example, if the renter node 330 received and decrypted the data associated with the first transaction credential, then the renter node 330 would also have access to the data (e.g., plain text data). In this regard, the third party node may have no way of establishing that the data has not been modified, for example, by the renter node 330, without performing other procedures. However, in cases where the third party node 332 requests the data directly from the transaction management system 315 and is able to decrypt the received data, the provenance (e.g., authenticity) of the data may automatically be assumed by the third party node 332, based on the transfer process and the third party node being able to decrypt the data.

Additionally or alternatively, different services may be associated with different transaction credentials to facilitate transfer of ownership and access to data between different entities. For example, a first transaction credential may be associated with a first service (e.g., operation data of the car such as speed, braking, force sensors, location sensors, or the like) and a second transaction credential may be associated with a second service (e.g., maintenance such as oil change, tires, etc.). In this example, ownership of data associated with the first service may be transferred to a different entity (e.g., a renter) via the data management system 300. Additionally, the car owner may retain ownership of the data associated with the second service. Accordingly, different types of data or services can be independently transferred via different transaction credentials.

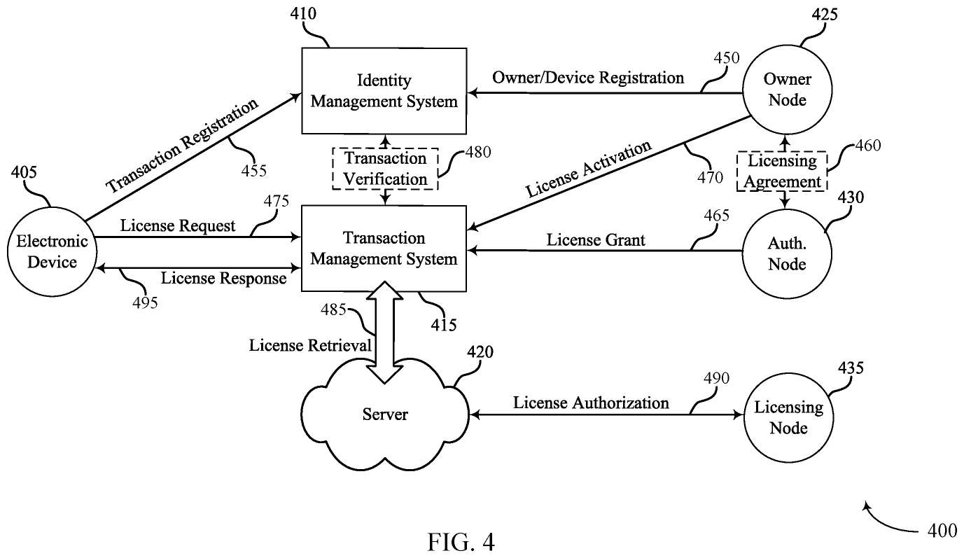

FIG. 4 illustrates an example of a data management system 400 that supports architecture for device ownership, data provenance, governance and trade in a licensing and device management example. The process flow illustrates a licensing request and grant sequence for activation of restricted or locked features on a device. In some examples, the data management system 400 may implement aspects of data management systems 100, 200 or 300. The data management system 400 may include an electronic device 405, which may be an example of an electronic device 105, medical device 205, rental car 305, or other electronic device as described with reference to FIGS. 1, 2 and 3 and herein; an identity management system 410, which may be an example of the identity management system 110, 210 or 310 as described with reference to FIGS. 1-3; a transaction management system 415, which may be an example of the transaction management system 115, 215 or 315 as described with reference to FIGS. 1-3; a server 420, which may be an example of the data storage 120, 220 or 320 described with reference to FIGS. 1-3; an owner node 425, which may be an example of the owner/owner device 125, patient node 225, car owner node 325 as described with reference to FIGS. 1-3; an authorization node 430; and a licensing node 435.

The process flow shown for data management system 400 illustrates an example of a licensing/authorization process for the electronic device 405 to activate one or more features or capabilities that are initially locked, deactivated, or otherwise not accessible by the electronic device. For example, the electronic device 405 may include one or more semi-conductor chips or chip sets. The chips in the electronic device 405 may contain a number of discrete capabilities, however, only a limited subset of these capabilities may be active in the electronic device 405. In some cases, an owner of the electronic device 405 may reach an agreement with the producer or licensor of the chips to activate the initially locked or restricted features. In this regard, the data management system 400 may support the process for securely activating the one or more restricted features on the electronic device 405.

At 450, the owner node 425 may register the management ID, owner credential, the electronic device ID, and device credential at the identity management system 410 which may be an example of the registration processes 255 and 355 described in relation to FIGS. 2 and 3.

At 455 the electronic device 405 may transmit a transaction registration to the identity management system 410, which may include a transaction credential signed by the electronic device 405. In some cases, the transaction credential may be signed using a master credential registered by the owner node 425 at the identity management system 410, for example at step 450. In some cases, the owner node may resister the transaction credential for the electronic device 405. In some examples, the transaction credential may be a public key or hash of a public key that is transmitted to the identity management system 410.

At 460, the owner node 425 and authorization node 430 may form a licensing agreement, for example, for activating one or more restricted or locked features on the electronic device. In some cases, the licensing agreement may include an agreement for a certain value worth of features. For example, the owner node 425 may be granted access to choose to activate different features of one or more electronic devices 405 until the activated features reach a certain value. In other cases, the owner node 425 may receive a certain amount of credits to apply to activating restricted features. In this regard, the owner node 425 can activate different features at different times for one or more electronic device using the granted credits.

At 465, the authorization node 430 may transmit a license grant to the transaction management system 415. The licensing grant may indicate that the owner node 425 has been granted access to one or more licenses for one or more electronic devices 405. In some examples, the licensing grant may indicate that the owner node 425 has been granted a specific value or specific number of credits that can be used for activating licenses for the electronic device(s) 405. The licensing grant may be signed by the authorization node 430, for example using an authorization credential.

At 470, the owner node 425 may transmit a licensing activation to the transaction management system 415. The licensing activation may include a transaction credential identifying the electronic device 405 and a value or credit that may be applied to activating one or more restricted features for that device. In some cases, the licensing activation may indicate a specific feature or capability that the electronic device 405 is authorized to activate.

At 475, the electronic device 405 may transmit a licensing request to the transaction management system 415 to activate one or more restricted features for one or more components (e.g., semi-conductor chip, or the like) of the electronic device 405. The licensing request may include the transaction credential associated with the electronic device and identify a specific license or license type.

At 480, the transaction management system 415 may verify the transaction credential received from the electronic device 405 with the identity management system 410. The transaction verification may be an example of the transaction verifications 265 or 365 as described in relation to FIGS. 2 and 3.

At 485, the transaction management system 485 may send a license retrieval request to a server 420 requesting a license for accessing the restricted features at the electronic device 405. At 490, the server may communicate the licensing retrieval request to the licensing node 435 and receive a license authorization in response. In some cases, the license authorization may include a license for activating the restricted features on electronic device 405. At 495, the transaction management system 415 may transmit the license associated with the transaction credential to the electronic device 405. The electronic device 405 may use the license to active the one or more locked or restricted features or capabilities. In some cases, the electronic device 405 may transmit an activation completion indication to the transaction management system 415. The transaction management system 415 may register that the license activation is complete and deduct the credits or value from a record associated with the owner node 425.

In some cases, that data management system 400 may support processes that allow different programs, applications or services associated with the electronic device 405 to accesses different data or information available to the electronic device 405 based on license state for each program, application or service. For example, the electronic device 405 may be a user equipment (UE) device as described herein and running one or more applications that transfer data over a network (e.g., mobile network). As such, the electronic device 405 may have access to wireless information used to communicate data associated with an application. This may include wireless information or parameters related to link quality, mobility information, connection configurations (e.g., carrier aggregation or dual connectivity information), or the like. In some cases, the electronic device may allow certain applications to access the wireless information based on a license state associated with each application. For example, a first application running on the electronic device 405 may be associated with a first license state and a second application running on the electronic device may be associated with a second license state. The wireless device 405, may allow the first application to access a first set of information elements (IEs) associated with the wireless information and allow the second application to access a second set of IEs that are different from the first. For example, the second set of IEs may be more restricted set of IEs than the first set.

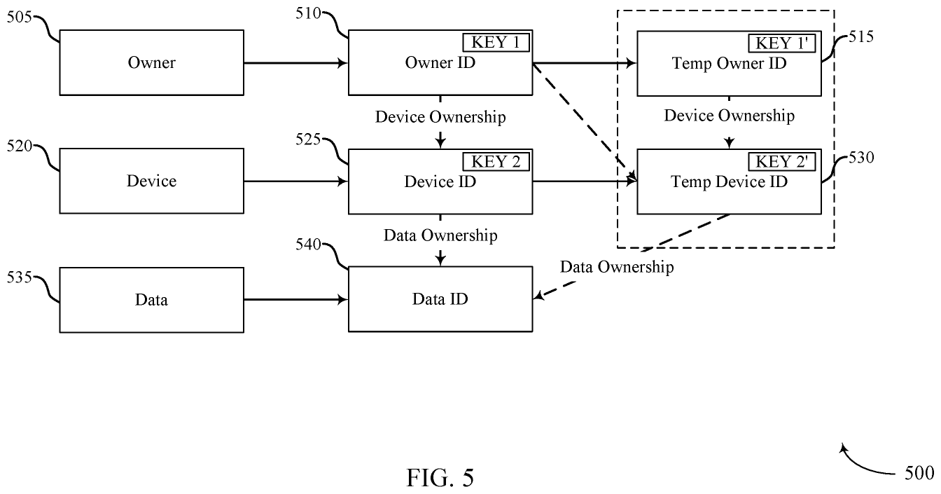

FIG. 5 illustrates an example of a data ownership system 500 that supports architecture for device ownership, data provenance, governance and trade in accordance with aspects of the present disclosure. In some examples, the data ownership system 500 may implement aspects of data management systems 100, 200, 300 or 400. The data ownership system may include an owner node 505, which may be an example of the owner device 125, patient node 225, car owner node 325 or owner node 425 described with reference to FIGS. 1-4; a device 520, which may be an example of the device 105, the medical device 205, the rental car 305 or the electronic device 405 described with reference to FIGS. 1-4; and a data node 535, which may be an example of data described with reference to FIGS. 1-4. The data ownership system 500 may also include an owner ID 510, a device ID 525 and a data ID 540. In some cases, the data ownership system 500 may further include a temporary owner ID 515 or a temporary device ID 530.

The owner node 505 may establish an owner ID 510 through an authentication procedure such a personal identification number or biometric authentication. In some cases, the owner ID 510 may also be associated with a first authentication key (e.g., Key 1), which may be an example of a management credential as described with reference to FIGS. 2-4. The device 520 may establish a device ID 525 through a device provisioning or key generation process. In some cases, the device ID 525 may also be associated with an authentication key (e.g., Key 2), which may be an example of a transaction credential described in relation to FIGS. 2-4. Additionally or alternatively, the data node 535 may establish a data ID 540, for example, using a crypto hash that identifies the data generated at the device 520.

The owner ID 510 may be associated with the device ID 525 or establish ownership over the device 520 by registering the device ID 525 at an identity management system (e.g., identity management system 110, 210, 310 or 410) and signing the registration of the device using the first authentication key (e.g., Key 1). In some cases, the device ID may also be associated with the data ID 540 or establish a relationship to the data ID by registering the data ID 540 at a transaction management system (e.g., transaction management system 115, 215, 315 or 415).

In some cases, the owner ID 510 may be associated with a temporary owner ID 515. For example, the owner ID 510 may be associated with the temporary owner ID using a temporary management credential and register the association to an identity management system. Similarly, the device ID 525 may be associated with a temporary device ID 530. For example, the device ID 525 may be associated with the temporary device ID and register the association to a transaction management system. In this regard, the temporary owner ID may be associated with or establish ownership over the device ID 525 or temporary device ID using a third authentication key (e.g., Key 1′). In some examples, the temporary device ID 530 may be associated with or establish ownership over the data produced with data ID 540 using a fourth authentication key (e.g., Key 2′). In other examples, the owner ID 510 may be associated with or establish ownership over the temporary device ID 530 using the first management credential (e.g., Key 1). Accordingly, the data ownership system 500 may establish ownership or associate an owner node 505 with a device 520 and data 535 produced by the device.

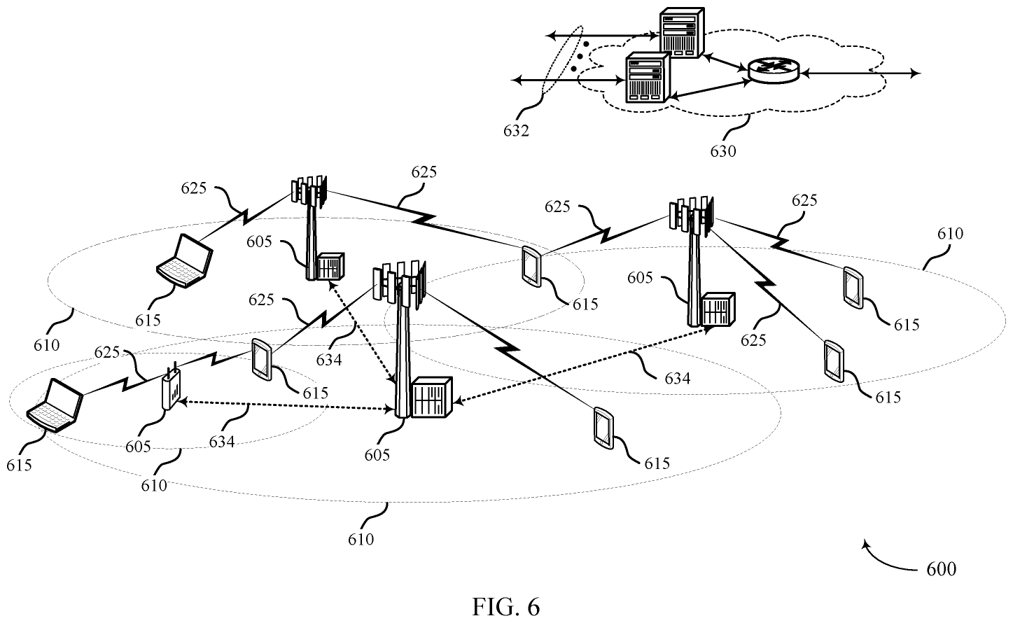

FIG. 6 illustrates an example of a wireless communications system 600 that supports architecture for device ownership, data provenance, governance and trade in accordance with aspects of the present disclosure. The wireless communications system 600 includes base stations 605, UEs 615, and a core network 630. In some examples, the wireless communications system 600 may be a Long Term Evolution (LTE) network, an LTE-Advanced (LTE-A) network, an LTE-A Pro network, or a New Radio (NR) network. In some cases, wireless communications system 600 may support enhanced broadband communications, ultra-reliable (e.g., mission critical) communications, low latency communications, or communications with low-cost and low-complexity devices.

Base stations 605 may wirelessly communicate with UEs 615 via one or more base station antennas. Base stations 605 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 600 may include base stations 605 of different types (e.g., macro or small cell base stations). The UEs 615 described herein may be able to communicate with various types of base stations 605 and network equipment including macro eNBs, small cell eNBs, gNBs, relay base stations, and the like.

Each base station 605 may be associated with a particular geographic coverage area 610 in which communications with various UEs 615 is supported. Each base station 605 may provide communication coverage for a respective geographic coverage area 610 via communication links 625, and communication links 625 between a base station 605 and a UE 615 may utilize one or more carriers. Communication links 625 shown in wireless communications system 600 may include uplink transmissions from a UE 615 to a base station 605, or downlink transmissions from a base station 605 to a UE 615. Downlink transmissions may also be called forward link transmissions while uplink transmissions may also be called reverse link transmissions.

The geographic coverage area 610 for a base station 605 may be divided into sectors making up a portion of the geographic coverage area 610, and each sector may be associated with a cell. For example, each base station 605 may provide communication coverage for a macro cell, a small cell, a hot spot, or other types of cells, or various combinations thereof. In some examples, a base station 605 may be movable and therefore provide communication coverage for a moving geographic coverage area 610. In some examples, different geographic coverage areas 610 associated with different technologies may overlap, and overlapping geographic coverage areas 610 associated with different technologies may be supported by the same base station 605 or by different base stations 605. The wireless communications system 600 may include, for example, a heterogeneous LTE/LTE-A/LTE-A Pro or NR network in which different types of base stations 605 provide coverage for various geographic coverage areas 610.

The term “cell” refers to a logical communication entity used for communication with a base station 605 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 610 (e.g., a sector) over which the logical entity operates.

UEs 615 may be dispersed throughout the wireless communications system 600, and each UE 615 may be stationary or mobile. A UE 615 may also be referred to as a mobile device, a wireless device, a remote device, a handheld device, or a subscriber device, or some other suitable terminology, where the “device” may also be referred to as a unit, a station, a terminal, or a client. A UE 615 may also be a personal electronic device such as a cellular phone, a personal digital assistant (PDA), a tablet computer, a laptop computer, or a personal computer. In some examples, a UE 615 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 615, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 605 without human intervention. In some examples, M2M communication or MTC may include communications from devices that integrate sensors or meters to measure or capture information and relay that information to a central server or application program that can make use of the information or present the information to humans interacting with the program or application. Some UEs 615 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 615 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 615 include entering a power saving “deep sleep” mode when not engaging in active communications, or operating over a limited bandwidth (e.g., according to narrowband communications). In some cases, UEs 615 may be designed to support critical functions (e.g., mission critical functions), and a wireless communications system 600 may be configured to provide ultra-reliable communications for these functions.

In some cases, a UE 615 may also be able to communicate directly with other UEs 615 (e.g., using a peer-to-peer (P2P) or device-to-device (D2D) protocol). One or more of a group of UEs 615 utilizing D2D communications may be within the geographic coverage area 610 of a base station 605. Other UEs 615 in such a group may be outside the geographic coverage area 610 of a base station 605, or be otherwise unable to receive transmissions from a base station 605. In some cases, groups of UEs 615 communicating via D2D communications may utilize a one-to-many (1:M) system in which each UE 615 transmits to every other UE 615 in the group. In some cases, a base station 605 facilitates the scheduling of resources for D2D communications. In other cases, D2D communications are carried out between UEs 615 without the involvement of a base station 605.

Base stations 605 may communicate with the core network 630 and with one another. For example, base stations 605 may interface with the core network 630 through backhaul links 632 (e.g., via an S1, N2, N3, or other interface). Base stations 605 may communicate with one another over backhaul links 634 (e.g., via an X2, Xn, or other interface) either directly (e.g., directly between base stations 605) or indirectly (e.g., via core network 630).

The core network 630 may provide user authentication, access authorization, tracking, Internet Protocol (IP) connectivity, and other access, routing, or mobility functions. The core network 630 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 615 served by base stations 605 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 605, may include subcomponents such as an access network entity, which may be an example of an access node controller (ANC). Each access network entity may communicate with UEs 615 through a number of other access network transmission entities, which may be referred to as a radio head, a smart radio head, or a transmission/reception point (TRP). In some configurations, various functions of each access network entity or base station 605 may be distributed across various network devices (e.g., radio heads and access network controllers) or consolidated into a single network device (e.g., a base station 605).

Wireless communications system 600 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 615 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 600 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that may be capable of tolerating interference from other users.

Wireless communications system 600 may also operate in an extremely high frequency (EHF) region of the spectrum (e.g., from 30 GHz to 300 GHz), also known as the millimeter band. In some examples, wireless communications system 600 may support millimeter wave (mmW) communications between UEs 615 and base stations 605, and EHF antennas of the respective devices may be even smaller and more closely spaced than UHF antennas. In some cases, this may facilitate use of antenna arrays within a UE 615. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 600 may utilize both licensed and unlicensed radio frequency spectrum bands. For example, wireless communications system 600 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 605 and UEs 615 may employ listen-before-talk (LBT) procedures to ensure a frequency channel is clear before transmitting data. In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 605 or UE 615 may be equipped with multiple antennas, which may be used to employ techniques such as transmit diversity, receive diversity, multiple-input multiple-output (MIMO) communications, or beamforming. For example, wireless communications system 600 may use a transmission scheme between a transmitting device (e.g., a base station 605) and a receiving device (e.g., a UE 615), where the transmitting device is equipped with multiple antennas and the receiving device is equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 605 or a UE 615) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 605 may use multiple antennas or antenna arrays to conduct beamforming operations for directional communications with a UE 615. For instance, some signals (e.g. synchronization signals, reference signals, beam selection signals, or other control signals) may be transmitted by a base station 605 multiple times in different directions, which may include a signal being transmitted according to different beamforming weight sets associated with different directions of transmission. Transmissions in different beam directions may be used to identify (e.g., by the base station 605 or a receiving device, such as a UE 615) a beam direction for subsequent transmission and/or reception by the base station 605.

Some signals, such as data signals associated with a particular receiving device, may be transmitted by a base station 605 in a single beam direction (e.g., a direction associated with the receiving device, such as a UE 615). In some examples, the beam direction associated with transmissions along a single beam direction may be determined based at least in in part on a signal that was transmitted in different beam directions. For example, a UE 615 may receive one or more of the signals transmitted by the base station 605 in different directions, and the UE 615 may report to the base station 605 an indication of the signal it received with a highest signal quality, or an otherwise acceptable signal quality. Although these techniques are described with reference to signals transmitted in one or more directions by a base station 605, a UE 615 may employ similar techniques for transmitting signals multiple times in different directions (e.g., for identifying a beam direction for subsequent transmission or reception by the UE 615), or transmitting a signal in a single direction (e.g., for transmitting data to a receiving device).

A receiving device (e.g., a UE 615, which may be an example of a mmW receiving device) may try multiple receive beams when receiving various signals from the base station 605, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based at least in part on listening according to different receive beam directions (e.g., a beam direction determined to have a highest signal strength, highest signal-to-noise ratio, or otherwise acceptable signal quality based at least in part on listening according to multiple beam directions).

In some cases, the antennas of a base station 605 or UE 615 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 605 may be located in diverse geographic locations. A base station 605 may have an antenna array with a number of rows and columns of antenna ports that the base station 605 may use to support beamforming of communications with a UE 615. Likewise, a UE 615 may have one or more antenna arrays that may support various MIMO or beamforming operations.

In some cases, wireless communications system 600 may be a packet-based network that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use hybrid automatic repeat request (HARD) to provide retransmission at the MAC layer to improve link efficiency. In the control plane, the Radio Resource Control (RRC) protocol layer may provide establishment, configuration, and maintenance of an RRC connection between a UE 615 and a base station 605 or core network 630 supporting radio bearers for user plane data. At the Physical layer, transport channels may be mapped to physical channels.

In some cases, UEs 615 and base stations 605 may support retransmissions of data to increase the likelihood that data is received successfully. HARQ feedback is one technique of increasing the likelihood that data is received correctly over a communication link 625. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ= 1/30,720,000 seconds. Time intervals of a communications resource may be organized according to radio frames each having a duration of 10 milliseconds (ms), where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 600, and may be referred to as a transmission time interval (TTI). In other cases, a smallest scheduling unit of the wireless communications system 600 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 615 and a base station 605.

The term “carrier” refers to a set of radio frequency spectrum resources having a defined physical layer structure for supporting communications over a communication link 625. For example, a carrier of a communication link 625 may include a portion of a radio frequency spectrum band that is operated according to physical layer channels for a given radio access technology. Each physical layer channel may carry user data, control information, or other signaling. A carrier may be associated with a pre-defined frequency channel (e.g., an evolved universal mobile telecommunication system terrestrial radio access (E-UTRA) absolute radio frequency channel number (EARFCN)), and may be positioned according to a channel raster for discovery by UEs 615. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as orthogonal frequency division multiplexing (OFDM) or discrete Fourier transform spread OFDM (DFT-S-OFDM)).

The organizational structure of the carriers may be different for different radio access technologies (e.g., LTE, LTE-A, LTE-A Pro, NR). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 600. For example, the carrier bandwidth may be one of a number of predetermined bandwidths for carriers of a particular radio access technology (e.g., 1.4, 3, 5, 10, 15, 20, 40, or 80 MHz). In some examples, each served UE 615 may be configured for operating over portions or all of the carrier bandwidth. In other examples, some UEs 615 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 615 receives and the higher the order of the modulation scheme, the higher the data rate may be for the UE 615. In MIMO systems, a wireless communications resource may refer to a combination of a radio frequency spectrum resource, a time resource, and a spatial resource (e.g., spatial layers), and the use of multiple spatial layers may further increase the data rate for communications with a UE 615.

Devices of the wireless communications system 600 (e.g., base stations 605 or UEs 615) may have a hardware configuration that supports communications over a particular carrier bandwidth, or may be configurable to support communications over one of a set of carrier bandwidths. In some examples, the wireless communications system 600 may include base stations 605 and/or UEs 615 that support simultaneous communications via carriers associated with more than one different carrier bandwidth.

Wireless communications system 600 may support communication with a UE 615 on multiple cells or carriers, a feature which may be referred to as carrier aggregation or multi-carrier operation. A UE 615 may be configured with multiple downlink component carriers and one or more uplink component carriers according to a carrier aggregation configuration. Carrier aggregation may be used with both FDD and TDD component carriers.

In some cases, wireless communications system 600 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 615 that are not capable of monitoring the whole carrier bandwidth or are otherwise configured to use a limited carrier bandwidth (e.g., to conserve power).

In some cases, an eCC may utilize a different symbol duration than other component carriers, which may include use of a reduced symbol duration as compared with symbol durations of the other component carriers. A shorter symbol duration may be associated with increased spacing between adjacent subcarriers. A device, such as a UE 615 or base station 605, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications system 600 may be an NR system that may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across the frequency domain) and horizontal (e.g., across the time domain) sharing of resources.

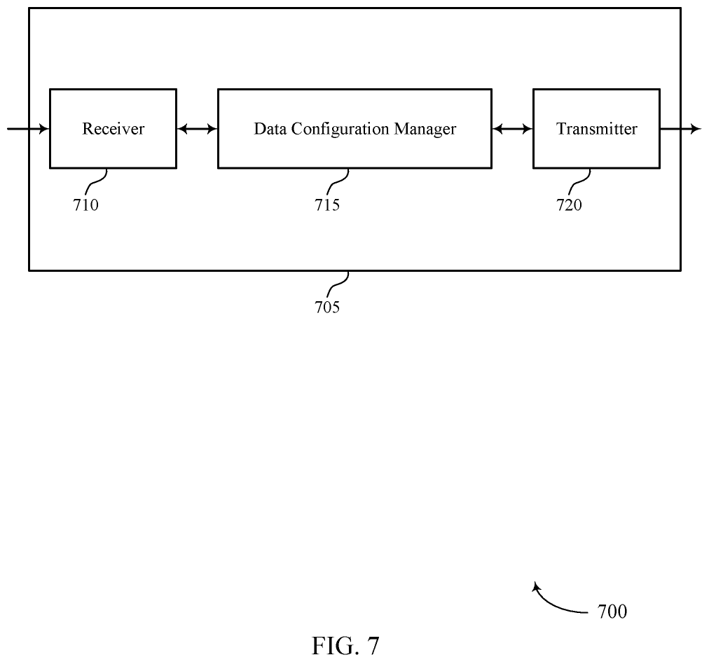

FIG. 7 shows a block diagram 700 of a device 705 that supports architecture for device ownership, data provenance, governance and trade in accordance with aspects of the present disclosure. The device 705 may be an example of aspects of a UE 615 as described herein. The device 705 may include a receiver 710, a data configuration manager 715, and a transmitter 720. The device 705 may also include a processor. Each of these components may be in communication with one another (e.g., via one or more buses).

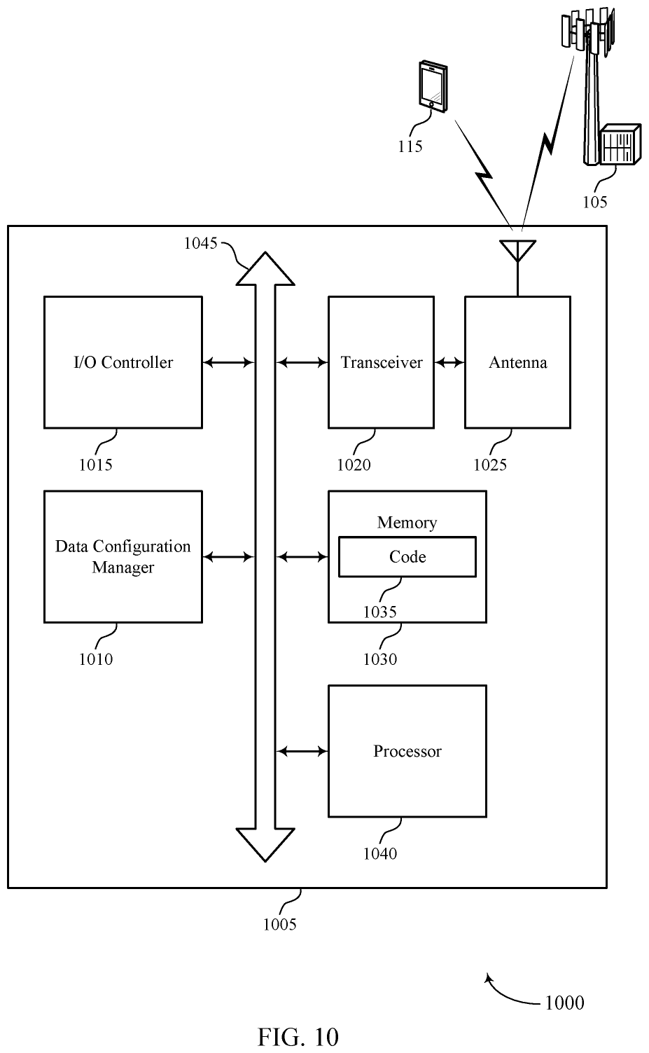

The receiver 710 may receive information such as packets, user data, or control information associated with various information channels (e.g., control channels, data channels, and information related to architecture for device ownership, data provenance, governance and trade, etc.). Information may be passed on to other components of the device 705. The receiver 710 may be an example of aspects of the transceiver 1020 described with reference to FIG. 10. The receiver 710 may utilize a single antenna or a set of antennas.

The data configuration manager 715 may receive, at the device, a device configuration profile including one or more parameters for managing data transfers associated with a service, generate, at the device, a transaction credential by which the data is to be associated in the storage, the transaction credential generated according to the device configuration profile, identify, at the device, that data is to be stored in a storage associated with the service, transmit the signed data to the storage, and sign the data using the transaction credential. The data configuration manager 715 may be an example of aspects of the data configuration manager 1010 described herein.

The data configuration manager 715, or its sub-components, may be implemented in hardware, code (e.g., software or firmware) executed by a processor, or any combination thereof. If implemented in code executed by a processor, the functions of the data configuration manager 715, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The data configuration manager 715, or its sub-components, may be physically located at various positions, including being distributed such that portions of functions are implemented at different physical locations by one or more physical components. In some examples, the data configuration manager 715, or its sub-components, may be a separate and distinct component in accordance with various aspects of the present disclosure. In some examples, the data configuration manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The actions performed by the data configuration manager 715 as described herein may be implemented to realize one or more potential advantages. One implementation may allow a device 705 to provide improved quality and reliability of service at the device 705 by ensuring the authenticity of data. The processes described herein allows for encryption of data at the device, where the owner remains control over the data, and can associate data produced at the device with different transaction IDs allowing the owner to independently transfer different types of data.

The transmitter 720 may transmit signals generated by other components of the device 705. In some examples, the transmitter 720 may be collocated with a receiver 710 in a transceiver module. For example, the transmitter 720 may be an example of aspects of the transceiver 1020 described with reference to FIG. 10. The transmitter 720 may utilize a single antenna or a set of antennas.

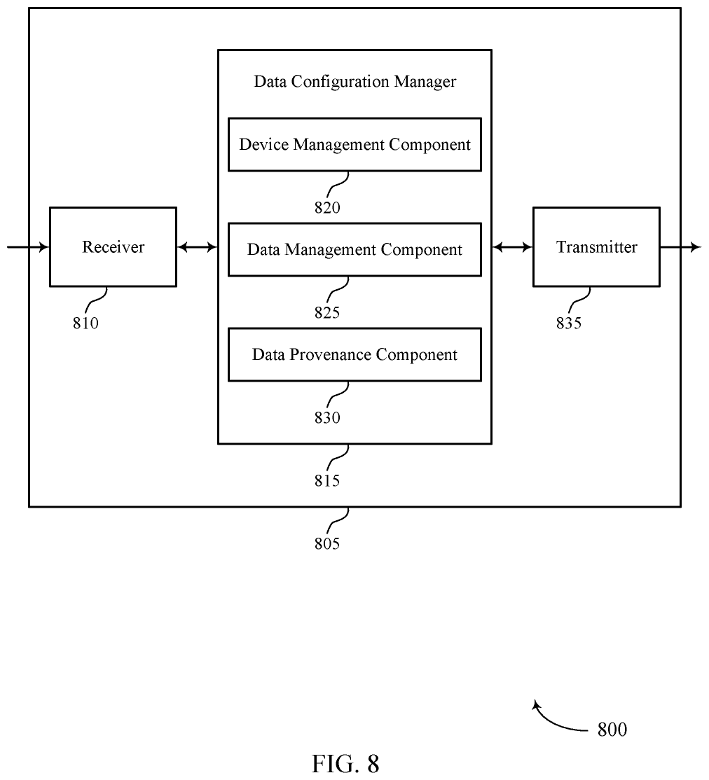

FIG. 8 shows a block diagram 800 of a device 805 that supports architecture for device ownership, data provenance, governance and trade in accordance with aspects of the present disclosure. The device 805 may be an example of aspects of a device 705, or a UE 615 as described herein. The device 805 may include a receiver 810, a data configuration manager 815, and a transmitter 835. The device 805 may also include a processor. Each of these components may be in communication with one another (e.g., via one or more buses).

The receiver 810 may receive information such as packets, user data, or control information associated with various information channels (e.g., control channels, data channels, and information related to architecture for device ownership, data provenance, governance and trade, etc.). Information may be passed on to other components of the device 805. The receiver 810 may be an example of aspects of the transceiver 1020 described with reference to FIG. 10. The receiver 810 may utilize a single antenna or a set of antennas.

The data configuration manager 815 may be an example of aspects of the data configuration manager 715 as described herein. The data configuration manager 815 may include a device management component 820, a data management component 825, and a data provenance component 830. The data configuration manager 815 may be an example of aspects of the data configuration manager 1010 described herein.

The device management component 820 may receive, at the device, a device configuration profile including one or more parameters for managing data transfers associated with a service.

The data management component 825 may generate, at the device, a transaction credential by which the data is to be associated in the storage, the transaction credential generated according to the device configuration profile, identify, at the device, that data is to be stored in a storage associated with the service, and transmit the signed data to the storage.

The data provenance component 830 may sign the data using the transaction credential.

The transmitter 835 may transmit signals generated by other components of the device 805. In some examples, the transmitter 835 may be collocated with a receiver 810 in a transceiver module. For example, the transmitter 835 may be an example of aspects of the transceiver 1020 described with reference to FIG. 10. The transmitter 835 may utilize a single antenna or a set of antennas.

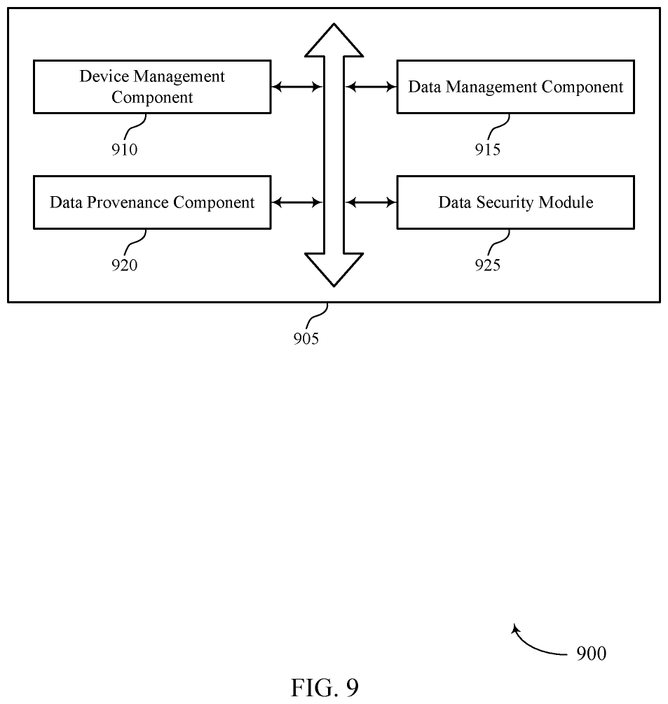

FIG. 9 shows a block diagram 900 of a data configuration manager 905 that supports architecture for device ownership, data provenance, governance and trade in accordance with aspects of the present disclosure. The data configuration manager 905 may be an example of aspects of a data configuration manager 715, a data configuration manager 815, or a data configuration manager 1010 described herein. The data configuration manager 905 may include a device management component 910, a data management component 915, a data provenance component 920, and a data security module 925. Each of these modules may communicate, directly or indirectly, with one another (e.g., via one or more buses).

The device management component 910 may receive, at the device, a device configuration profile including one or more parameters for managing data transfers associated with a service. In some examples, the device management component 910 may receive a data production policy.

The data management component 915 may generate, at the device, a transaction credential by which the data is to be associated in the storage, the transaction credential generated according to the device configuration profile. In some examples, the data management component 915 may identify, at the device, that data is to be stored in a storage associated with the service. In some examples, the data management component 915 may transmit the signed data to the storage. In some examples, the data management component 915 may transmit the signed transaction credential to an identity management system. In some examples, the data management component 915 may obtain the data, at the device, according to the data production policy. In some cases, the transmitting includes sending the signed transaction credential to the identity management system that is independent from the storage. In some cases, the transaction credential is associated with the service.

The data provenance component 920 may sign the data using the transaction credential. In some examples, the data provenance component 920 may generate, at the device, a transaction credential registration request by signing the transaction credential with a device credential. In some cases, the device credential is a permanent credential associated with the device. In some cases, the transaction credential and the device credential are based on a device identification associated with the device. In some cases, the device identification includes a temporary device identification. In some cases, the transaction credential and the device credential are based on the temporary device identification. In some cases, the device identification remains private based on using the temporary device identification.

The data security module 925 may encrypt the data prior to transmitting the signed data to the storage. In some examples, the data security module 925 may receive a security policy from the identity management system. In some examples, the data security module 925 may encrypt, at the device, the data based on the received security policy.

FIG. 10 shows a diagram of a system 1000 including a device 1005 that supports architecture for device ownership, data provenance, governance and trade in accordance with aspects of the present disclosure. The device 1005 may be an example of or include the components of device 705, device 805, or a UE 615 as described herein. The device 1005 may include components for bi-directional voice and data communications including components for transmitting and receiving communications, including a data configuration manager 1010, an I/O controller 1015, a transceiver 1020, an antenna 1025, memory 1030, and a processor 1040. These components may be in electronic communication via one or more buses (e.g., bus 1045).

The data configuration manager 1010 may receive, at the device, a device configuration profile including one or more parameters for managing data transfers associated with a service, generate, at the device, a transaction credential by which the data is to be associated in the storage, the transaction credential generated according to the device configuration profile, identify, at the device, that data is to be stored in a storage associated with the service, transmit the signed data to the storage, and sign the data using the transaction credential.

The I/O controller 1015 may manage input and output signals for the device 1005. The I/O controller 1015 may also manage peripherals not integrated into the device 1005. In some cases, the I/O controller 1015 may represent a physical connection or port to an external peripheral. In some cases, the I/O controller 1015 may utilize an operating system such as iOS®, ANDROID®, MS-DOS®, MS-WINDOWS®, OS/2®, UNIX®, LINUX®, or another known operating system. In other cases, the I/O controller 1015 may represent or interact with a modem, a keyboard, a mouse, a touchscreen, or a similar device. In some cases, the I/O controller 1015 may be implemented as part of a processor. In some cases, a user may interact with the device 1005 via the I/O controller 1015 or via hardware components controlled by the I/O controller 1015.

The transceiver 1020 may communicate bi-directionally, via one or more antennas, wired, or wireless links as described above. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the wireless device may include a single antenna 1025. However, in some cases the device may have more than one antenna 1025, which may be capable of concurrently transmitting or receiving multiple wireless transmissions.

The memory 1030 may include RAM and ROM. The memory 1030 may store computer-readable, computer-executable code 1035 including instructions that, when executed, cause the processor to perform various functions described herein. In some cases, the memory 1030 may contain, among other things, a BIOS which may control basic hardware or software operation such as the interaction with peripheral components or devices.

The processor 1040 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting architecture for device ownership, data provenance, governance and trade).

Based on processes for supporting data provenance, the processor 1040 may efficiently determine the authenticity of data which may in turn improve reliability of service. As such, the processor 1040 may be ready to respond more efficiently through the reduction of a ramp up in processing power.

The code 1035 may include instructions to implement aspects of the present disclosure, including instructions to support wireless communications. The code 1035 may be stored in a non-transitory computer-readable medium such as system memory or other type of memory. In some cases, the code 1035 may not be directly executable by the processor 1040 but may cause a computer (e.g., when compiled and executed) to perform functions described herein.

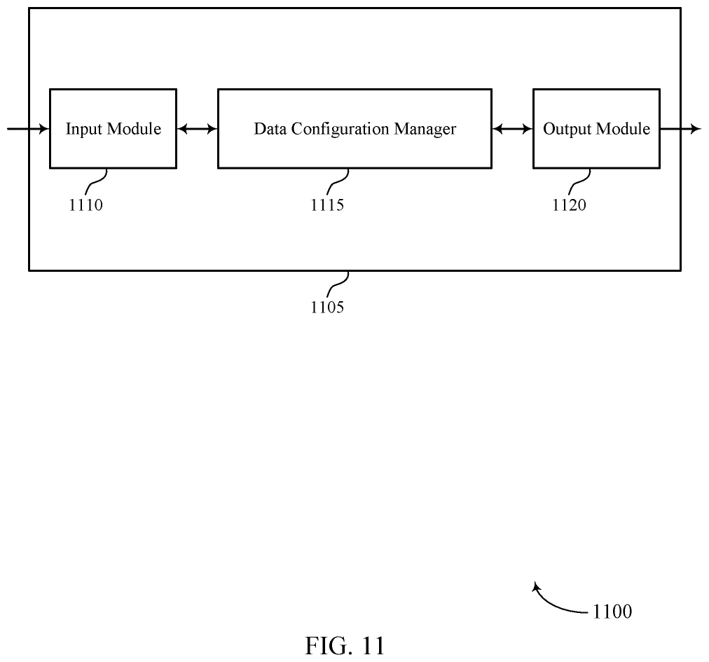

FIG. 11 shows a block diagram 1100 of a device 1105 that supports architecture for device ownership, data provenance, governance and trade in accordance with aspects of the present disclosure. The device 1105 may be an example of aspects of a application server as described herein. The device 1105 may include an input module 1110, a data configuration manager 1115, and an output module 1120. The device 1105 may also include a processor. Each of these components may be in communication with one another (e.g., via one or more buses).

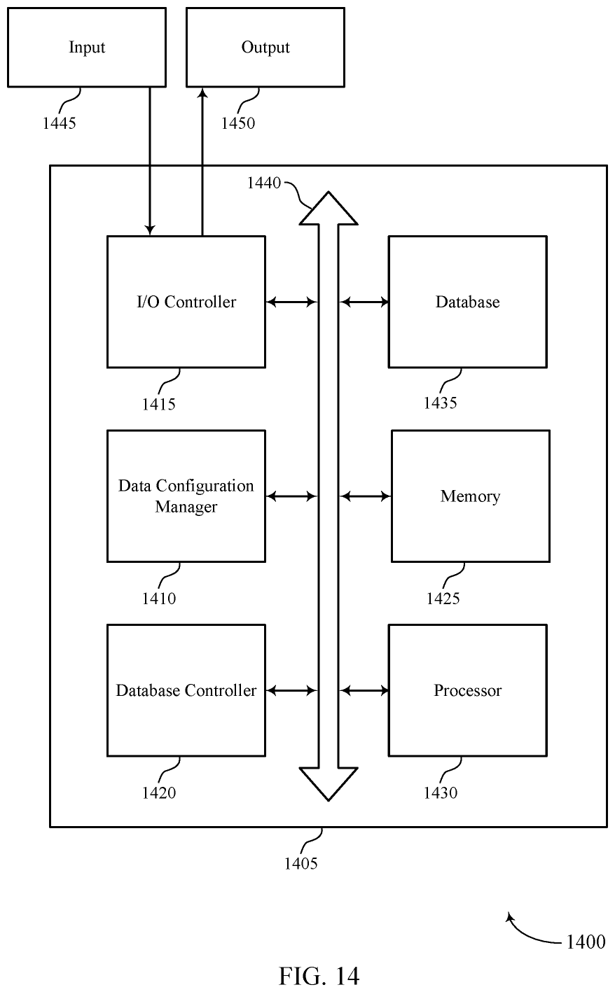

The input module 1110 may manage input signals for the apparatus 1105. For example, the input module 1110 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 1110 may send aspects of these input signals to other components of the apparatus 1105 for processing. For example, the input module 1110 may transmit input signals to the data retention module 1115 to support data retention handling for data object stores. In some cases, the input module 1110 may be a component of an input/output (I/O) controller 1415 as described with reference to FIG. 14.

The data configuration manager 1115 may receive a device registration request for registration of a device credential associated with a device, receive a transaction registration request for registration of a transaction credential by which data transmitted by the device is to be associated in a storage, receive a transaction verification request for verification that data transmitted by the device is associated with the transaction credential, and verify, in response to the transaction verification request, that the transaction credential is associated with the device. The data configuration manager 1115 may also receive a data transmission from a device, where the data transmission includes data signed using a transaction credential associated with the device, associate the data and the transaction credential in a storage network based on successful verification with the identity management node, communicate with an identity management node to verify that the transaction credential and the device are associated with each other, receive a request from an authorized entity to provide the data associated with the transaction credential, and provide the data in response to the request. The data configuration manager 1115 may be an example of aspects of the data configuration manager 1410 described herein.

The data configuration manager 1115, or its sub-components, may be implemented in hardware, code (e.g., software or firmware) executed by a processor, or any combination thereof. If implemented in code executed by a processor, the functions of the data configuration manager 1115, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The data configuration manager 1115, or its sub-components, may be physically located at various positions, including being distributed such that portions of functions are implemented at different physical locations by one or more physical components. In some examples, the data configuration manager 1115, or its sub-components, may be a separate and distinct component in accordance with various aspects of the present disclosure. In some examples, the data configuration manager 1115, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The actions performed by the data configuration manager 1115 as described herein may be implemented to realize one or more potential advantages. One implementation may allow a device 1105 to provide improved quality and reliability of service at the device 1105 by ensuring the authenticity of data. The processes described herein allows for encryption of data at the device, where the owner remains control over the data, and can associate data produced at the device with different transaction IDs allowing the owner to independently transfer different types of data.

The output module 1120 may manage output signals for the apparatus 1105. For example, the output module 1120 may receive signals from other components of the apparatus 1105, such as the data retention module 1115, and may transmit these signals to other components or devices. In some specific examples, the output module 1120 may transmit output signals for display in a user interface, for storage in a database or data store, for further processing at a server or server cluster, or for any other processes at any number of devices or systems. In some cases, the output module 1120 may be a component of an I/O controller 1415 as described with reference to FIG. 14.

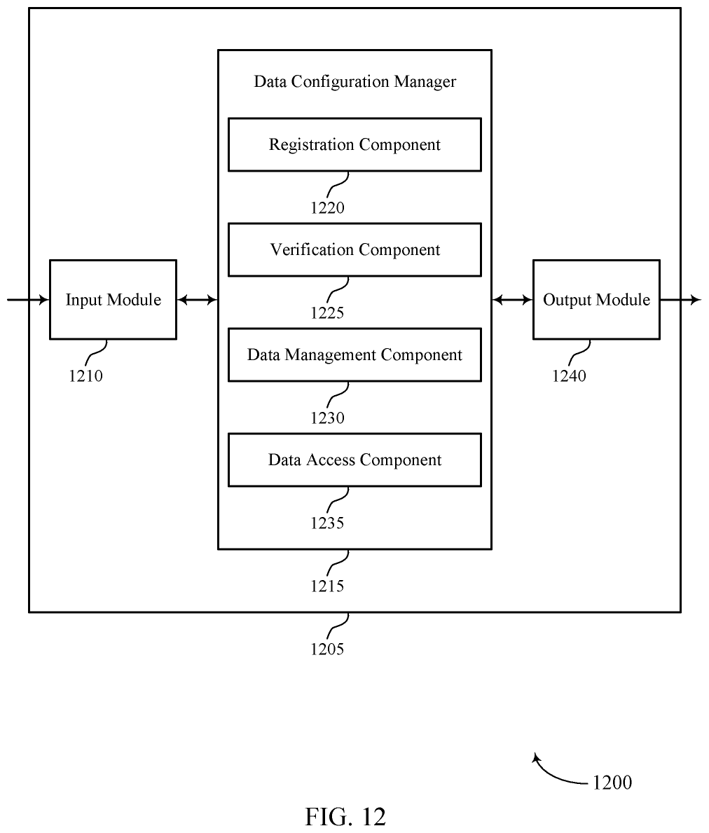

FIG. 12 shows a block diagram 1200 of an apparatus 1205 that supports architecture for device ownership, data provenance, governance and trade in accordance with aspects of the present disclosure. The device 1205 may be an example of aspects of a device 1105 or a UE 615 as described herein. The apparatus 1205 may include an input module 1210, a data configuration manager 1215, and an output module 1240. The apparatus 1205 may also include a processor. Each of these components may be in communication with one another (e.g., via one or more buses). In some cases, the apparatus 1205 may be an example of a user terminal, a database server, or a system containing multiple computing devices.

The input module 1210 may manage input signals for the apparatus 1205. For example, the input module 1210 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 1210 may send aspects of these input signals to other components of the apparatus 1205 for processing. For example, the input module 1210 may transmit input signals to the data retention module 1215 to support data retention handling for data object stores. In some cases, the input module 1210 may be a component of an input/output (I/O) controller 1415 as described with reference to FIG. 14.

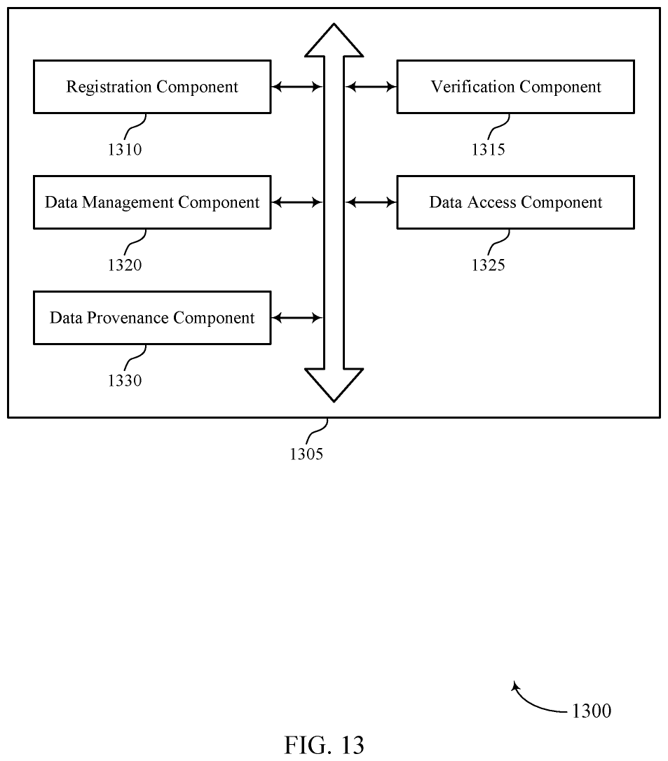

The data configuration manager 1215 may be an example of aspects of the data configuration manager 1115 as described herein. The data configuration manager 1215 may include a registration component 1220, a verification component 1225, a data management component 1230, and a data access component 1235. The data configuration manager 1215 may be an example of aspects of the data configuration manager 1305 or 1410 described with reference to FIGS. 13 and 14.

The data configuration manager 1215 and/or at least some of its various sub-components may be implemented in hardware, software executed by a processor, firmware, or any combination thereof. If implemented in software executed by a processor, the functions of the data configuration manager 1215 and/or at least some of its various sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure. The data configuration manager 1215 and/or at least some of its various sub-components may be physically located at various positions, including being distributed such that portions of functions are implemented at different physical locations by one or more physical devices. In some examples, the data configuration manager 1215 and/or at least some of its various sub-components may be a separate and distinct component in accordance with various aspects of the present disclosure. In other examples, the data configuration manager 1215 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The registration component 1220 may receive a device registration request for registration of a device credential associated with a device and receive a transaction registration request for registration of a transaction credential by which data transmitted by the device is to be associated in a storage.

The verification component 1225 may receive a transaction verification request for verification that data transmitted by the device is associated with the transaction credential and verify, in response to the transaction verification request, that the transaction credential is associated with the device.

The data management component 1230 may receive a data transmission from a device, where the data transmission includes data signed using a transaction credential associated with the device and associate the data and the transaction credential in a storage network based on successful verification with the identity management node.

The verification component 1225 may communicate with an identity management node to verify that the transaction credential and the device are associated with each other.

The data access component 1235 may receive a request from an authorized entity to provide the data associated with the transaction credential and provide the data in response to the request.

The output module 1240 may manage output signals for the apparatus 1205. For example, the output module 1240 may receive signals from other components of the apparatus 1205, such as the data retention module 1215, and may transmit these signals to other components or devices. In some specific examples, the output module 1240 may transmit output signals for display in a user interface, for storage in a database or data store, for further processing at a server or server cluster, or for any other processes at any number of devices or systems. In some cases, the output module 1240 may be a component of an I/O controller 1415 as described with reference to FIG. 14.

FIG. 13 shows a block diagram 1300 of a data configuration manager 1305 that supports architecture for device ownership, data provenance, governance and trade in accordance with aspects of the present disclosure. The data configuration manager 1305 may be an example of aspects of a data configuration manager 1115, a data configuration manager 1215, or a data configuration manager 1410 described herein. The data configuration manager 1305 may include a registration component 1310, a verification component 1315, a data management component 1320, a data access component 1325, and a data provenance component 1330. Each of these modules may communicate, directly or indirectly, with one another (e.g., via one or more buses).

The registration component 1310 may receive a device registration request for registration of a device credential associated with a device. In some examples, the registration component 1310 may receive a transaction registration request for registration of a transaction credential by which data transmitted by the device is to be associated in a storage. In some examples, the registration component 1310 may receive, from the device, a signed transaction registration request, where the signed transaction registration request is based on the device credential. In some examples, the registration component 1310 may verify that the transaction credential is associated with the device based on comparing the signed transaction registration request to the device credential. In some examples, the registration component 1310 may receive an owner registration request for registration of an owner credential associated with the device, where the device registration request is based on the owner credential. In some examples, the registration component 1310 may associate the transaction credential received from the device with the owner credential based on the device credential associated with the device. In some examples, the registration component 1310 may receive a device ownership transfer request associated with the device. In some examples, the registration component 1310 may associate a second transaction credential received from the device with a second owner credential based on the device ownership transfer request, where the second transaction credential is received from the device after the device ownership transfer request.

The verification component 1315 may receive a transaction verification request for verification that data transmitted by the device is associated with the transaction credential. In some examples, the verification component 1315 may verify, in response to the transaction verification request, that the transaction credential is associated with the device. In some examples, the verification component 1315 may communicate with an identity management node to verify that the transaction credential and the device are associated with each other. In some examples, the verification component 1315 may receive a transaction verification identifier from a transaction management system that is independent from the device. In some examples, the verification component 1315 may verify that the transaction credential is associated with the device based on comparing the transaction verification identifier with the transaction credential and the device credential received from the device.

The data management component 1320 may receive a data transmission from a device, where the data transmission includes data signed using a transaction credential associated with the device. In some examples, the data management component 1320 may associate the data and the transaction credential in a storage network based on successful verification with the identity management node.

The data access component 1325 may receive a request from an authorized entity to provide the data associated with the transaction credential. In some examples, the data access component 1325 may provide the data in response to the request. In some examples, receiving an access grant for the authorized entity to access the data associated with the transaction credential, where the access grant includes an ownership credential and access credential. In some examples, the data access component 1325 may communicate with the identity management node to verifying that the transaction credential and the ownership credential are associated with each other. In some examples, the data access component 1325 may receive the transaction credential in the request from the authorized entity, where the transaction credential is signed by the access credential. In some examples, the data access component 1325 may validate the request from the authorized entity based at least in part receiving the access credential. In some examples, the data access component 1325 may retrieve the data associated with the transaction credential. In some examples, the data access component 1325 may record the access grant for the authorized entity based on verifying that the transaction credential and the ownership credential are associated with each other.

In some examples, providing the data includes transmitting encrypted data to the authorized entity. In some examples, receiving a request from the device to access one or more locked capabilities of the device, where the request includes the transaction credential.

In some examples, the data access component 1325 may receive an access authorization credential associated with the transaction credential. In some examples, the data access component 1325 may verify the request based on receiving the access authorization credential. In some examples, receiving a license grant for the one or more locked capabilities, where providing the data includes sending the license grant to the device. In some cases, the access grant for the authorized entity is limited to the data associated with the transaction credential.

The data provenance component 1330 may validate an authenticity of the data based on verifying the transaction credential associated with the data. In some examples, the data provenance component 1330 may communicate the validation to the authorized entity.

FIG. 14 shows a diagram of a system 1400 including a device 1405 that supports architecture for device ownership, data provenance, governance and trade in accordance with aspects of the present disclosure. The device 1405 may be an example of or include the components of an application server or an apparatus 1105, device 1205, or a application server as described herein. The device 1405 may include components for bi-directional data communications including components for transmitting and receiving communications, including a data configuration manager 1410, an I/O controller 1415, a database controller 1420, memory 1425, a processor 1430, and a database 1435. These components may be in electronic communication via one or more buses (e.g., bus 1440).

The data configuration manager 1410 may be an example of a data configuration manager 1215 or 1305 as described herein. For example, the data configuration manager 1410 may perform any of the methods or processes described above with reference to FIGS. 12 and 13. In some cases, the data configuration manager 1410 may be implemented in hardware, software executed by a processor, firmware, or any combination thereof.

The I/O controller 1415 may manage input signals 1445 and output signals 1450 for the device 1405. The I/O controller 1415 may also manage peripherals not integrated into the device 1405. In some cases, the I/O controller 1415 may represent a physical connection or port to an external peripheral. In some cases, the I/O controller 1415 may utilize an operating system such as iOS®, ANDROID®, MS-DOS®, MS-WINDOWS®, OS/2®, UNIX®, LINUX®, or another known operating system. In other cases, the I/O controller 1415 may represent or interact with a modem, a keyboard, a mouse, a touchscreen, or a similar device. In some cases, the I/O controller 1415 may be implemented as part of a processor. In some cases, a user may interact with the device 1405 via the I/O controller 1415 or via hardware components controlled by the I/O controller 1415.

The database controller 1420 may manage data storage and processing in a database 1435. In some cases, a user may interact with the database controller 1420. In other cases, the database controller 1420 may operate automatically without user interaction. The database 1435 may be an example of a single database, a distributed database, multiple distributed databases, a data store, a data lake, or an emergency backup database.

Memory 1425 may include random-access memory (RAM) and read-only memory (ROM). The memory 1425 may store computer-readable, computer-executable software including instructions that, when executed, cause the processor to perform various functions described herein. In some cases, the memory 1425 may contain, among other things, a basic input/output system (BIOS) which may control basic hardware or software operation such as the interaction with peripheral components or devices.

The processor 1430 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 1430 may be configured to operate a memory array using a memory controller. In other cases, a memory controller may be integrated into the processor 1430. The processor 1430 may be configured to execute computer-readable instructions stored in a memory 1425 to perform various functions (e.g., functions or tasks supporting architecture for device ownership, data provenance, governance and trade).

Based on processes for supporting data provenance, the processor 1430 may efficiently determine the authenticity of data which may in turn improve reliability of service. As such, the processor 1430 may be ready to respond more efficiently through the reduction of a ramp up in processing power.

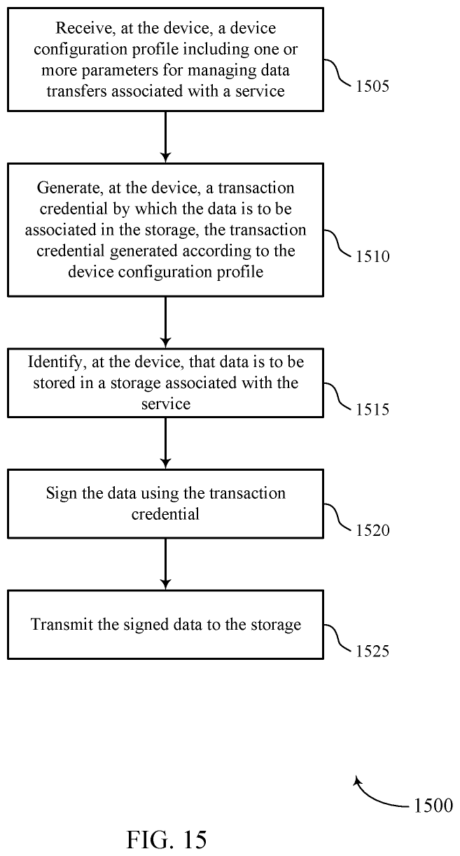

FIG. 15 shows a flowchart illustrating a method 1500 that supports architecture for device ownership, data provenance, governance and trade in accordance with aspects of the present disclosure. The operations of method 1500 may be implemented by a UE 615 or its components as described herein. For example, the operations of method 1500 may be performed by a data configuration manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1505, the UE may receive, at the device, a device configuration profile including one or more parameters for managing data transfers associated with a service. The operations of 1505 may be performed according to the methods described herein. In some examples, aspects of the operations of 1505 may be performed by a device management component as described with reference to FIGS. 7 through 10.

At 1510, the UE may generate, at the device, a transaction credential by which the data is to be associated in the storage, the transaction credential generated according to the device configuration profile. The operations of 1510 may be performed according to the methods described herein. In some examples, aspects of the operations of 1510 may be performed by a data management component as described with reference to FIGS. 7 through 10.

At 1515, the UE may identify, at the device, that data is to be stored in a storage associated with the service. The operations of 1515 may be performed according to the methods described herein. In some examples, aspects of the operations of 1515 may be performed by a data management component as described with reference to FIGS. 7 through 10.

At 1520, the UE may sign the data using the transaction credential. The operations of 1520 may be performed according to the methods described herein. In some examples, aspects of the operations of 1520 may be performed by a data provenance component as described with reference to FIGS. 7 through 10.

At 1525, the UE may transmit the signed data to the storage. The operations of 1525 may be performed according to the methods described herein. In some examples, aspects of the operations of 1525 may be performed by a data management component as described with reference to FIGS. 7 through 10.

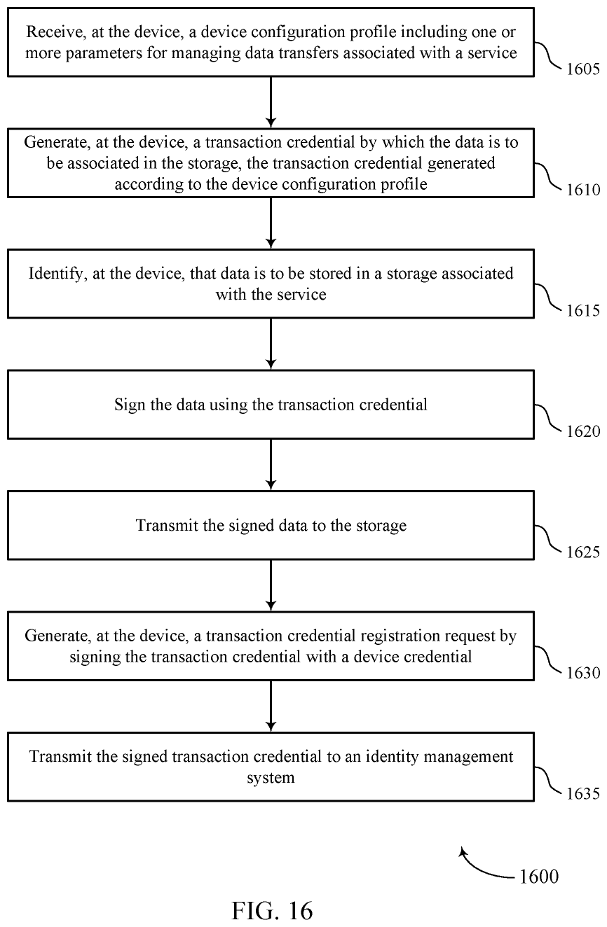

FIG. 16 shows a flowchart illustrating a method 1600 that supports architecture for device ownership, data provenance, governance and trade in accordance with aspects of the present disclosure. The operations of method 1600 may be implemented by a UE 615 or its components as described herein. For example, the operations of method 1600 may be performed by a data configuration manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1605, the UE may receive, at the device, a device configuration profile including one or more parameters for managing data transfers associated with a service. The operations of 1605 may be performed according to the methods described herein. In some examples, aspects of the operations of 1605 may be performed by a device management component as described with reference to FIGS. 7 through 10.

At 1610, the UE may generate, at the device, a transaction credential by which the data is to be associated in the storage, the transaction credential generated according to the device configuration profile. The operations of 1610 may be performed according to the methods described herein. In some examples, aspects of the operations of 1610 may be performed by a data management component as described with reference to FIGS. 7 through 10.

At 1615, the UE may identify, at the device, that data is to be stored in a storage associated with the service. The operations of 1615 may be performed according to the methods described herein. In some examples, aspects of the operations of 1615 may be performed by a data management component as described with reference to FIGS. 7 through 10.

At 1620, the UE may sign the data using the transaction credential. The operations of 1620 may be performed according to the methods described herein. In some examples, aspects of the operations of 1620 may be performed by a data provenance component as described with reference to FIGS. 7 through 10.

At 1625, the UE may transmit the signed data to the storage. The operations of 1625 may be performed according to the methods described herein. In some examples, aspects of the operations of 1625 may be performed by a data management component as described with reference to FIGS. 7 through 10.

At 1630, the UE may generate, at the device, a transaction credential registration request by signing the transaction credential with a device credential. The operations of 1630 may be performed according to the methods described herein. In some examples, aspects of the operations of 1630 may be performed by a data provenance component as described with reference to FIGS. 7 through 10.

At 1635, the UE may transmit the signed transaction credential to an identity management system. The operations of 1635 may be performed according to the methods described herein. In some examples, aspects of the operations of 1635 may be performed by a data management component as described with reference to FIGS. 7 through 10.

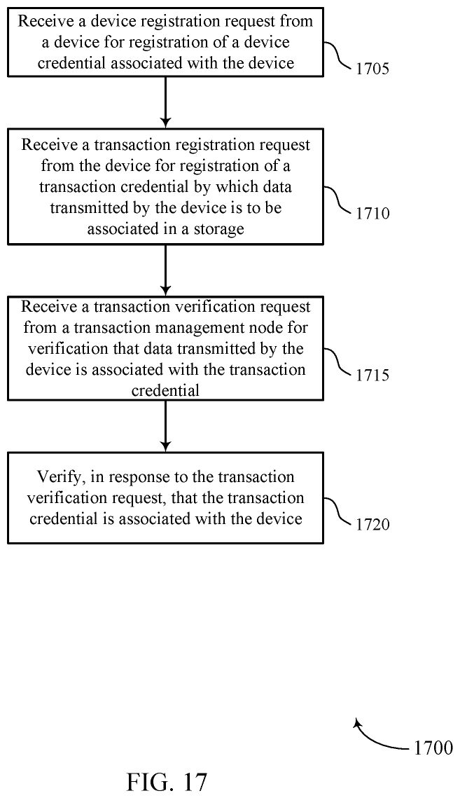

FIG. 17 shows a flowchart illustrating a method 1700 that supports architecture for device ownership, data provenance, governance and trade in accordance with aspects of the present disclosure. The operations of method 1700 may be implemented by a application server or its components as described herein. For example, the operations of method 1700 may be performed by a data configuration manager as described with reference to FIGS. 11 through 14. In some examples, a application server may execute a set of instructions to control the functional elements of the application server to perform the functions described below. Additionally or alternatively, a application server may perform aspects of the functions described below using special-purpose hardware.

At 1705, the application server may receive a device registration request for registration of a device credential associated with a device. The operations of 1705 may be performed according to the methods described herein. In some examples, aspects of the operations of 1705 may be performed by a registration component as described with reference to FIGS. 11 through 14.

At 1710, the application server may receive a transaction registration request for registration of a transaction credential by which data transmitted by the device is to be associated in a storage. The operations of 1710 may be performed according to the methods described herein. In some examples, aspects of the operations of 1710 may be performed by a registration component as described with reference to FIGS. 11 through 14.

At 1715, the application server may receive a transaction verification request for verification that data transmitted by the device is associated with the transaction credential. The operations of 1715 may be performed according to the methods described herein. In some examples, aspects of the operations of 1715 may be performed by a verification component as described with reference to FIGS. 11 through 14.

At 1720, the application server may verify, in response to the transaction verification request, that the transaction credential is associated with the device. The operations of 1720 may be performed according to the methods described herein. In some examples, aspects of the operations of 1720 may be performed by a verification component as described with reference to FIGS. 11 through 14.

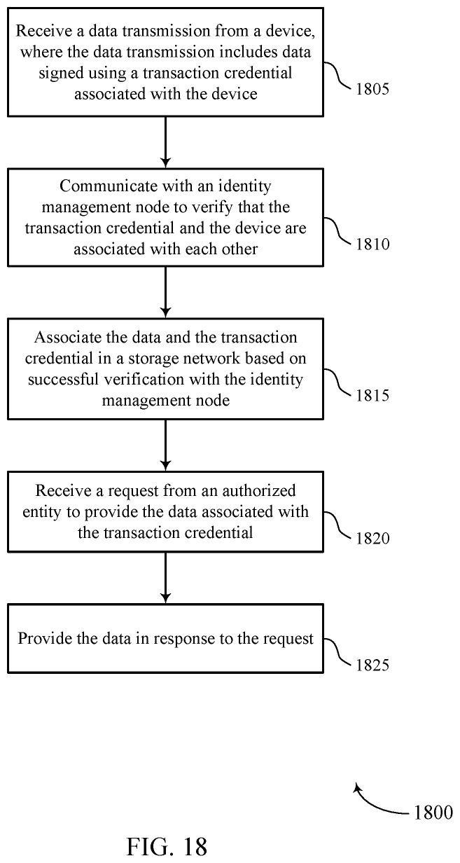

FIG. 18 shows a flowchart illustrating a method 1800 that supports architecture for device ownership, data provenance, governance and trade in accordance with aspects of the present disclosure. The operations of method 1800 may be implemented by a application server or its components as described herein. For example, the operations of method 1800 may be performed by a data configuration manager as described with reference to FIGS. 11 through 14. In some examples, a application server may execute a set of instructions to control the functional elements of the application server to perform the functions described below. Additionally or alternatively, a application server may perform aspects of the functions described below using special-purpose hardware.

At 1805, the application server may receive a data transmission from a device, where the data transmission includes data signed using a transaction credential associated with the device. The operations of 1805 may be performed according to the methods described herein. In some examples, aspects of the operations of 1805 may be performed by a data management component as described with reference to FIGS. 11 through 14.

At 1810, the application server may communicate with an identity management node to verify that the transaction credential and the device are associated with each other. The operations of 1810 may be performed according to the methods described herein. In some examples, aspects of the operations of 1810 may be performed by a verification component as described with reference to FIGS. 11 through 14.

At 1815, the application server may associate the data and the transaction credential in a storage network based on successful verification with the identity management node. The operations of 1815 may be performed according to the methods described herein. In some examples, aspects of the operations of 1815 may be performed by a data management component as described with reference to FIGS. 11 through 14.

At 1820, the application server may receive a request from an authorized entity to provide the data associated with the transaction credential. The operations of 1820 may be performed according to the methods described herein. In some examples, aspects of the operations of 1820 may be performed by a data access component as described with reference to FIGS. 11 through 14.

At 1825, the application server may provide the data in response to the request. The operations of 1825 may be performed according to the methods described herein. In some examples, aspects of the operations of 1825 may be performed by a data access component as described with reference to FIGS. 11 through 14.

It should be noted that the methods described herein describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for communication at a device, comprising:
receiving, at the device, a device configuration profile comprising one or more parameters for managing data transfers associated with a service;
generating, at the device, a transaction credential by which the data is to be associated in the storage, the transaction credential generated according to the device configuration profile;
generating, at the device, a transaction credential registration request by signing the transaction credential with a device credential;
identifying, at the device, that data is to be stored in a storage associated with the service;
signing the data using the transaction credential;
transmitting the signed transaction credential to an identity management system; and
transmitting the signed data to the storage.

2. The method of claim 1, wherein the transmitting the signed transaction credential comprises:
sending the signed transaction credential to the identity management system that is independent from the storage,
wherein the device credential is a permanent credential associated with the device.

3. The method of claim 1, further comprising:
receiving a data production policy; and
obtaining the data, at the device, according to the data production policy.

4. The method of claim 1, further comprising:
encrypting the data prior to transmitting the signed data to the storage.

5. The method of claim 4, further comprising:
receiving a security policy from the identity management system; and
encrypting, at the device, the data based at least in part on the received security policy.

6. The method of claim 1, wherein the transaction credential and the device credential are based at least in part on a device identification associated with the device.

7. The method of claim 6, wherein:
the device identification comprises a temporary device identification;
the transaction credential and the device credential are based at least in part on the temporary device identification; and
the device identification remains private based at least in part on using the temporary device identification.

8. The method of claim 1, wherein the transaction credential is associated with the service.

9. A method for communication at an identity management node, comprising:
receiving a device registration request from a device for registration of a device credential associated with the device;
receiving a transaction registration request from the device for registration of a transaction credential by which data transmitted by the device is to be associated in a storage;
receiving a transaction verification request from a transaction management node for verification that data transmitted by the device is associated with the transaction credential; and
verifying, in response to the transaction verification request, that the transaction credential is associated with the device.

10. The method of claim 9, further comprising:
receiving, from the device, a signed transaction registration request, wherein the signed transaction registration request is based at least in part on the device credential.

11. The method of claim 10, further comprising:
verifying that the transaction credential is associated with the device based at least in part on comparing the signed transaction registration request to the device credential.

12. The method of claim 9, further comprising:
receiving an owner registration request for registration of an owner credential associated with the device, wherein the device registration request is based at least in part on the owner credential.

13. The method of claim 12, further comprising:
associating the transaction credential received from the device with the owner credential based at least in part on the device credential associated with the device.

14. The method of claim 12, further comprising:
receiving a device ownership transfer request associated with the device; and
associating a second transaction credential received from the device with a second owner credential based at least in part on the device ownership transfer request, wherein the second transaction credential is received from the device after the device ownership transfer request.

15. The method of claim 9, further comprising:
receiving a transaction verification identifier from a transaction management system that is independent from the device; and
verifying that the transaction credential is associated with the device based at least in part on comparing the transaction verification identifier with the transaction credential and the device credential received from the device.

16. A method for communication at a transaction management node, comprising:
receiving a data transmission from a device, wherein the data transmission includes data signed using a transaction credential associated with the device;
communicating with an identity management node to verify that the transaction credential and the device are associated with each other;
associating the data and the transaction credential in a storage network based at least in part on successful verification with the identity management node;
receiving a request from an authorized entity to provide the data associated with the transaction credential; and
providing the data in response to the request.

17. The method of claim 16, further comprising:
receiving an access grant for the authorized entity to access the data associated with the transaction credential, wherein the access grant comprises an ownership credential and access credential; and
communicating with the identity management node to verifying that the transaction credential and the ownership credential are associated with each other.

18. The method of claim 17, further comprising:
receiving the transaction credential in the request from the authorized entity, wherein the transaction credential is signed by the access credential;
validating the request from the authorized entity based at least in part receiving the access credential; and
retrieving the data associated with the transaction credential.

19. The method of claim 18, wherein the access grant for the authorized entity is limited to the data associated with the transaction credential.

20. the method of claim 17, further comprising:
recording the access grant for the authorized entity based at least in part on verifying that the transaction credential and the ownership credential are associated with each other.

21. The method of claim 16, further comprising:
validating an authenticity of the data based at least in part on verifying the transaction credential associated with the data; and
communicating the validation to the authorized entity.

22. The method of claim 16, wherein:
providing the data comprises transmitting encrypted data to the authorized entity.

23. The method of claim 16, further comprising:
receiving a request from the device to access one or more locked capabilities of the device, wherein the request comprises the transaction credential;
receiving an access authorization credential associated with the transaction credential;
verifying the request based at least in part on receiving the access authorization credential; and
receiving a license grant for the one or more locked capabilities, wherein providing the data comprises sending the license grant to the device.

24. An apparatus for communication at a device, comprising:
a processor,
memory in electronic communication with the processor; and
instructions stored in the memory and executable by the processor to cause the apparatus to:
receive, at the device, a device configuration profile comprising one or more parameters for managing data transfers associated with a service;
generate, at the device, a transaction credential by which the data is to be associated in the storage, the transaction credential generated according to the device configuration profile;
generate, at the device, a transaction credential registration request by signing the transaction credential with a device credential;
identify, at the device, that data is to be stored in a storage associated with the service;
sign the data using the transaction credential;
transmit the signed transaction credential to the identity management system; and
transmit the signed data to the storage.

25. The apparatus of claim 24, wherein:
the transmitting comprises sending the signed transaction credential to the identity management system that is independent from the storage; and
the device credential is a permanent credential associated with the device.

26. The apparatus of claim 24, wherein the instructions are further executable by the processor to cause the apparatus to:
receive a data production policy; and
obtain the data, at the device, according to the data production policy.

27. The apparatus of claim 24, wherein the instructions are further executable by the processor to cause the apparatus to:
receive a security policy from the identity management system; and
encrypt, at the device, the data based at least in part on the received security policy.

28. The apparatus of claim 24, wherein the transaction credential and the device credential are based at least in part on a device identification associated with the device.

29. The apparatus of claim 28, wherein:
the device identification comprises a temporary device identification;
the transaction credential and the device credential are based at least in part on the temporary device identification; and
the device identification remains private based at least in part on using the temporary device identification.

30. The apparatus of claim 24, wherein the transaction credential is associated with the service.
